(19) United States
(12) Patent Application Publication
(10) Pub. No.: US 2021/0003416 A1
(43) Pub. Date: Jan. 7, 2021

(54) Apparatus, Systems And Methods For Automatic Steering Guidance And Visualization Of Guidance Paths

(71) Applicant: Ag Leader Technology, Ames, IA (US)

(72) Inventors: David Wilson, Prairie City, IA (US); Trent Anagnostopoulos, Ankeny, IA (US); Mike Myers, Madison, WI (US); Steve Bruening, Nevada, IA (US); Zach Bartlett, Madison, WI (US); Joe Holoubek, Ames, IA (US)

(21) Appl. No.: 16/921,828

(22) Filed: Jul. 6, 2020

Related U.S. Application Data
(60) Provisional application No. 62/870,325, filed on Jul. 3, 2019.

(51) Int. Cl. G01C 21/36; A01B 69/04; G05D 1/00

(52) U.S. Cl. CPC G01C 21/3641; A01B 69/008; G05D 2201/0201; G01C 21/362; G05D 1/0044

(57) ABSTRACT

The disclosed apparatus, systems and methods relate to guidance and visualization systems for autosteering systems of agricultural implements. The system allows the operator to visualize the guidance paths throughout a field map or region to allow for the ability of the operator to make adjustments prior to engaging the auto steering unit, such as to row headings and positions.

### CROSS-REFERENCE TO RELATED APPLICATION(S)

This application claims priority to U.S. Provisional Application No. 62/870,325 filed Jul. 3, 2019 and entitled “Apparatus, Systems and Methods for Automatic Steering,” which is hereby incorporated by reference in its entirety under 35 U.S.C. § 119(e).

### TECHNICAL FIELD

The disclosed technology relates generally to automatic steering, and in particular, to the devices, methods, and design principles allowing for visualization and guidance of automatic steering systems on agricultural tractors and implements.

### BACKGROUND

The disclosure relates to devices, systems, and methods for improvements to guidance and automatic steering systems allowing for the visualization of field paths and more efficient planting, tilling, harvesting, and other agricultural processes over the prior art.

### BRIEF SUMMARY

Discussed herein are various devices, systems and methods relating to guidance for automatic steering systems.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In Example 1, an agricultural vehicle guidance visualization system for use with an automatic steering unit, comprising an operations unit, a display running a graphical user interface, a path system in operational communication with the operations #3198788 unit and display. The path system configured to input one or more field boundaries for a polygonal field map, plot a plurality of guidance paths, display heading, position, and offset for the plurality of plotted guidance paths, and adjust the heading, position, and/or offset of the plurality of plotted guidance paths.

In Example 2, the system of Example 1, wherein the path system is configured to command the automatic steering unit with the plurality of plotted guidance paths.

In Example 3, the system of Example 2, wherein the path system is configured to display and adjust the plurality of plotted guidance paths with at least one of an enterprise data adjustment, a squaring adjustment, or an offset adjustment.

In Example 4, the system of Example 3, wherein the squaring adjustment is configured to determine a guidance path corner radius, and display a user prompt querying a square off option.

In Example 5, the system of Example 1, wherein the path system is configured to display field obstacles.

In Example 6, the system of Example 1, wherein the one or more field map boundaries are drawn from stored boundary map data.

In Example 7, the system of Example 6, wherein the path system is configured to populate the stored boundary map data with one or more additional boundary points.

In Example 8, a visualization and guidance method for use with an agricultural vehicle automatic steering unit comprising executing a path system configured to plot a plurality of guidance paths in a field map via one or more field map boundaries, display the plurality of plotted guidance paths and any skips and overlaps for adjustment of plotted guidance path heading, position, and offset.

In Example 9, the method of Example 8, wherein the path system is configured to command the automatic steering unit.

In Example 10, the method of Example 8, wherein the path system is configured to display field map overlaps and skips.

In Example 11, the method of Example 1, wherein the path system is configured to utilize user defined offsets.

In Example 12, a visualization and guidance system for use with automatic steering of an agricultural vehicle, comprising a path system configured to run on an operations unit and in-cab display, wherein the path system is configured to input one or more field boundaries in a polygonal field map on the display, plot a plurality of guidance paths in the polygonal field map for display, display path heading position and offset for the plurality of guidance paths throughout the plotted field map, and adjust the heading, position and offset of the plurality of guidance paths.

In Example 13, the visualization and guidance system of Example 12, wherein the path system is configured to command the automatic steering unit.

In Example 14, the visualization and guidance system of Example 13, wherein the operations unit is in operational communication with a cloud server.

In Example 15, the visualization and guidance system of Example 12, further comprising a squaring adjustment system.

In Example 16, the system of Example 12, configured to command a steering unit.

In Example 17, the system of Example 12, wherein the system is configured to plot guidance paths through the field region on the basis of a user-defined A-B path.

In Example 18, the system of Example 12, wherein the path system is configured to display guidance path headings, positions, offsets, skips, and overlaps.

In Example 19, the system of Example 12, wherein the path system is configured to apply user defined offsets.

In Example 20, the system of Example 12, further comprising an enterprise management system.

While multiple embodiments are disclosed, still other embodiments of the disclosure will become apparent to those skilled in the art from the following detailed description, which shows and describes illustrative embodiments of the disclosed apparatus, systems and methods. As will be realized, the disclosed apparatus, systems and methods are capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1A is a front view of an agricultural vehicle fitted with the visualization and guidance system, according to one implementation.

FIG. 1A is a schematic overview of an operations unit and various components for the visualization and guidance system, according to one implementation.

FIG. 2 is a schematic overview of the visualization and guidance system path process, according to one implementation.

FIG. 3A is a graphical user interface on a display depicting a field map and interface, according to one implementation of the system.

FIG. 3B is a graphical user interface on a display depicting a field map and interface, according to one implementation of the system.

FIG. 3C is a graphical user interface on a display depicting a boundary map, according to one implementation of the system.

FIG. 3D is a zoomed view of the boundary map of FIG. 3C.

FIG. 3E is the boundary map of FIG. 3C having been populated with additional points, according to one implementation of the system.

FIG. 3F is a zoomed view of the boundary map of FIG. 3E.

FIG. 3G is the boundary map of FIGS. 3C-F showing a guidance path having been drawn by the system, according to one implementation.

FIG. 3H is a zoomed view of the implementation of FIG. 3G.

FIG. 3I is a zoomed view of a field map showing guidance paths drawn by the system, showing potential skips and overlaps, according to one implementation.

FIG. 3J is view of a graphical user interface showing a field map and potential skips, according to one implementation.

FIG. 4A is a view of a graphical user interface showing a generated guidance path in a field map, according to one implementation of the system.

FIG. 4B is a view of a view of the guidance path of FIG. 4A showing a second guidance path, according to one implementation of the system.

FIG. 4C is a field map and guidance path with offset, according to one implementation of the system.

FIG. 4D is a field map showing offsets around terrace boundaries, according to certain implementations of the system.

FIG. 4E is a portion of a field map showing guidance paths, according to certain implementations of the system.

FIG. 5A is a field map and guidance paths in showing offset, heading, and/or position adjustments between the rows, according to one implementation of the system.

FIG. 5B is a depiction of a graphical user interface showing offset, heading, and/or position adjustments, according to one implementation of the system.

FIG. 6A is a field map showing a one row pass, according to an exemplary implementation of the system.

FIG. 6B is a field map showing several guidance paths in regions, according to one implementation of the system.

FIG. 7 is a field map showing an implementation of the system plotting guidance paths for field entry and exit.

FIG. 8A is a depiction of several field maps displayed on a graphical user interface in an enterprise implementation of the system, according to one embodiment.

FIG. 8B is a zoomed view of the implementation of FIG. 8A.

FIG. 9 is a further depiction of several field maps displayed on a graphical user interface in an enterprise implementation of the system, according to one embodiment.

FIG. 10 is a depiction of a graphical user interface and field map, according to one embodiment of the system.

FIG. 11 is a schematic drawing showing the squaring system of certain visualization and guidance system implementations.

### DETAILED DESCRIPTION

The various embodiments disclosed or contemplated herein relate to an automated guidance system for use with automated steering and the associated devices and methods of use. In exemplary implementations, the disclosed systems allow for both automated path generation and automated path execution. That is, the system allows the user to map and plot paths or swaths through a field for execution by an assisted or automated steering system. The system thus provides the ability to automate the plotting and adjustment of offset, heading, and/or position so as to automate and more accurately plot the location and direction of rows in a field and maximize efficiency and ease.

The disclosed systems allow the end user to visualize guidance paths throughout an entire field or between several fields to improve both operator experience and efficiency. Various implementations of the systems disclosed herein relate to optional features that can be used to improve the function and ease of use of various guidance and plotting components. For example, various implementations allow for the adjustment of the offset, heading, and/or position of plotted guidance path so as to allow for optimization of the placement of planted rows through the field. Further implementations allow for the adjustment of certain offsets and planting patterns or arrangements according to received or stored data, field characteristics, or enterprise implementations. Implementations also allow for the automation of plotting the spacing and distance of any guess rows—normally about thirty inches. It is understood that as used herein, guess rows refer to adjacent, adjoining implement swaths.

Further implementations involve the plotting of guidance paths to address decisions about when to corner or square off. These developments represent technical improvements over the manual systems in the prior art, many of which required guess work by the user.

Importantly, in the disclosed implementations, the user is provided with a visualization of the various guidance features and options provided herein for use in optimizing the plotted guidance path offset, heading, and/or position in a given field or fields, including prior to engaging the automatic steering unit.

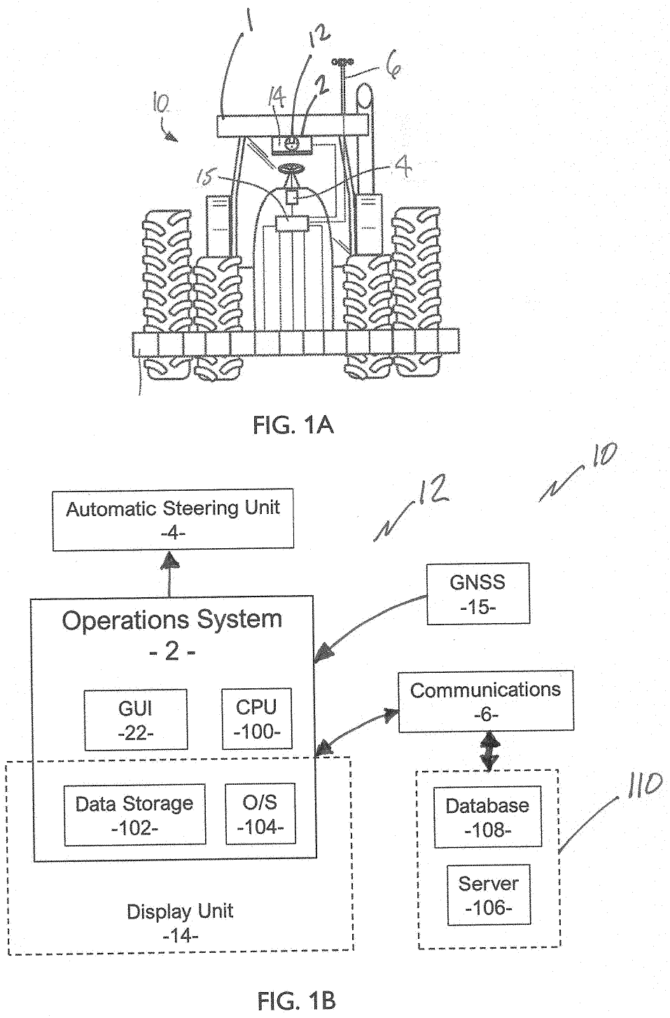

Turning to the drawings in greater detail, FIGS. 1A-1B depict exemplary implementations of the various visualization and guidance system 10 components fitted to an agricultural vehicle 1 such as a tractor 1, having an implement such as a planter. It is understood that a variety of vehicles 1 and implements can be utilized in various implementations. It is further understood that the components depicted in FIGS. 1A-1B are optional, and can be utilized or omitted in the various claimed implementations, and that certain additional components may be required to effectuate the various processes and systems described herein.

As shown in FIG. 1A, the visualization and guidance system 10 has an operations system 2 that comprises or is configured to be operationally integrated with a steering unit 4, such as SteerCommand®, and an optional communications component 6. The system 10 is operationally integrated with at least one in-cab display 14, such as an InCommand® display 14, or other suitable display 14 understood in the art. It is appreciated that certain of these displays 14 feature touchscreens, while others are equipped with necessary components for interaction with the various prompts and adjustments discussed herein, such as via a keyboard or other interface.

In various implementations, the system is also operationally integrated with a GNSS or GPS unit 15, such as a GPS 7500, such that the system 10 is configured to input positional data for use in defining boundaries, locating the tractor 1 and plotting guidance and the like, as would be readily appreciated from the present disclosure.

As shown in FIG. 1B, in various implementations, the operations system 2 is optionally in operational communication with the automatic steering unit 4 or controller 4, the communications component 6, and/or GNSS 15. In certain of these implementations, the operations system 2 is housed in the display 14, though the various components described herein can be housed elsewhere, as would be readily appreciated.

As shown in FIG. 1B, the operations system 2 further has one or more optional processing and computing components, such as a CPU/processor 100, data storage 102, operating system 104, and other computing components necessary for implementing the various technologies disclosed herein. It is appreciated that the various optional system components are in operational communication with one another via wired or wireless connections and are configured to perform the processes and execute the commands described herein.

In certain implementations, like that of FIG. 1B, the communications component 6 is configured for the sending and receiving of data for cloud 110 storage and processing, such as to a remote server 106, database 108, and/or other cloud computing components readily understood in the art. Such connections by the communications component 6 can be made wirelessly via understood internet and/or cellular technologies such as Bluetooth, WiFi, LTE, 3G, 4G, or 5G connections and the like. It is understood that in certain implementations, the communications component 6 and/or cloud 110 components comprise encryption or other data privacy components such as hardware, software, and/or firmware security aspects. In various implementations, the operator or enterprise manager or other third parties are able to receive notifications such as adjustment prompts and confirmation screens on their mobile devices, and in certain implementations can review the plotted guidance paths and make adjustments via their mobile phones.

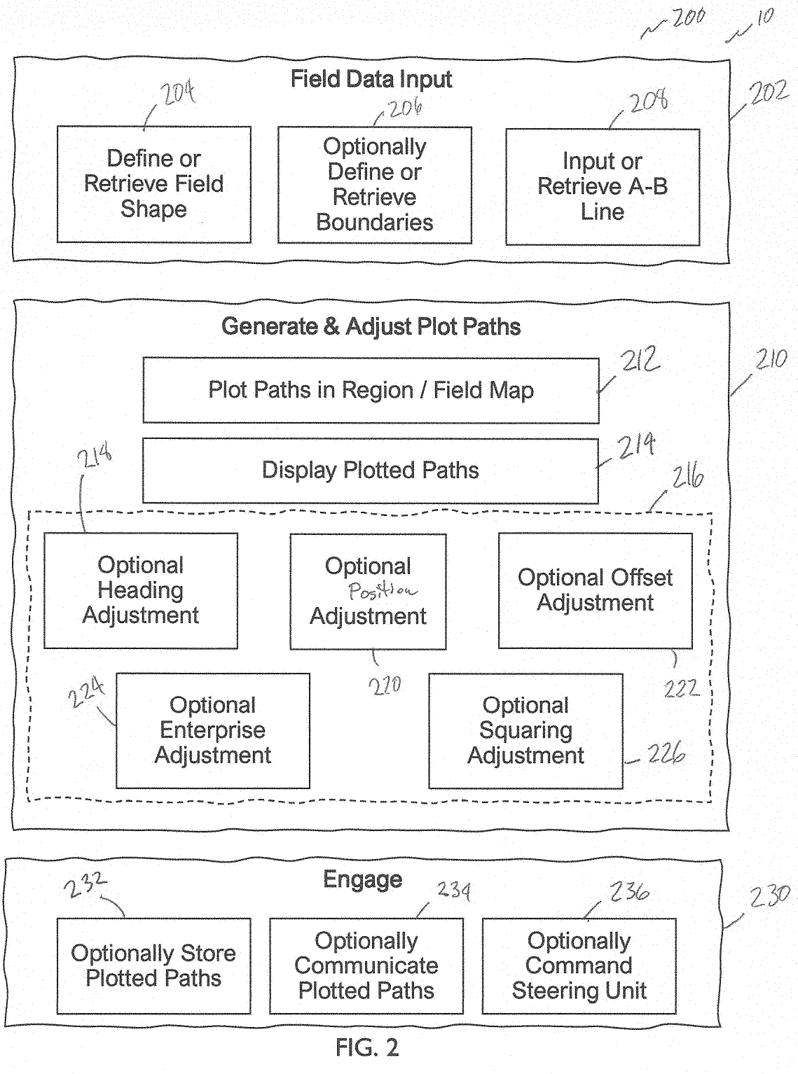

In use, various implementations of the system 10 and path system 12 comprise a variety of optional steps and sub-steps automating path plotting and execution. FIG. 2 depicts an exemplary process chart showing various optional aspects of the features and implementations described an illustrated below. It is understood that while FIG. 2 depicts one exemplary process 200 implementation of the path system 12, many other configurations are possible. Further, while each of the steps and sub-steps are described herein in an order, the various steps and sub-steps may be performed in alternate orders or simultaneously with one another, and each of the various steps is optional and can be omitted. Further, it is readily appreciated that the various steps may be iterated upon, such as when moving from one field map to the next, transmitting and receiving information, and plotting successive paths.

Various of the optional steps and sub-steps described in the model path system 12 process of FIG. 2, can be performed manually, via automation or calculation, or can be retrieved or commanded remotely, as would be readily understood.

Turning to FIG. 2 in greater detail, a series of steps comprising an optional field data input step (box 202), an optional path generation and adjustment step (box 210) and an optional engage step (box 230) are performed contemporaneously or sequentially in any order and in certain implementations iteratively, as would be readily appreciated.

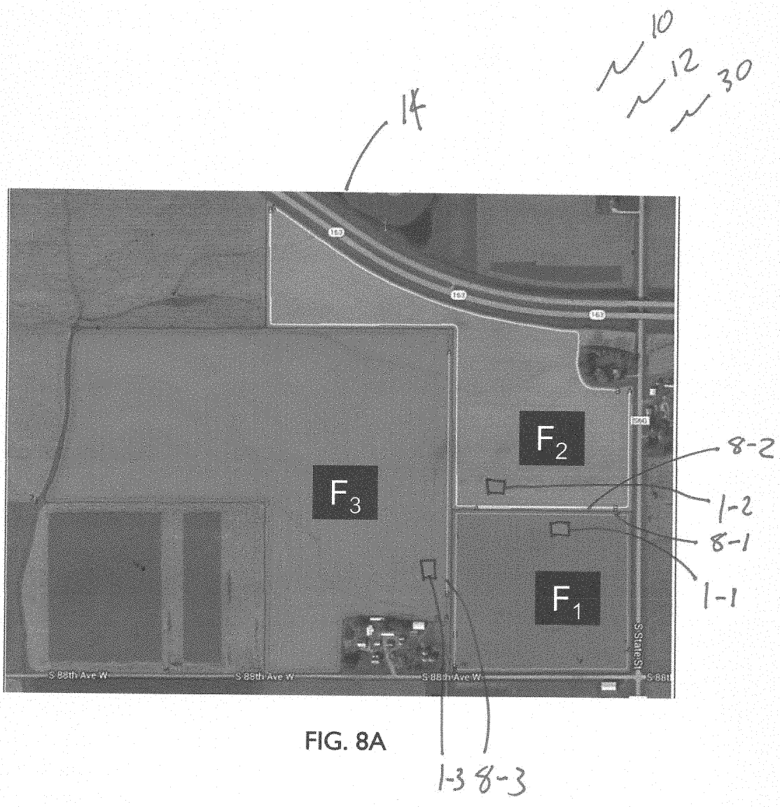

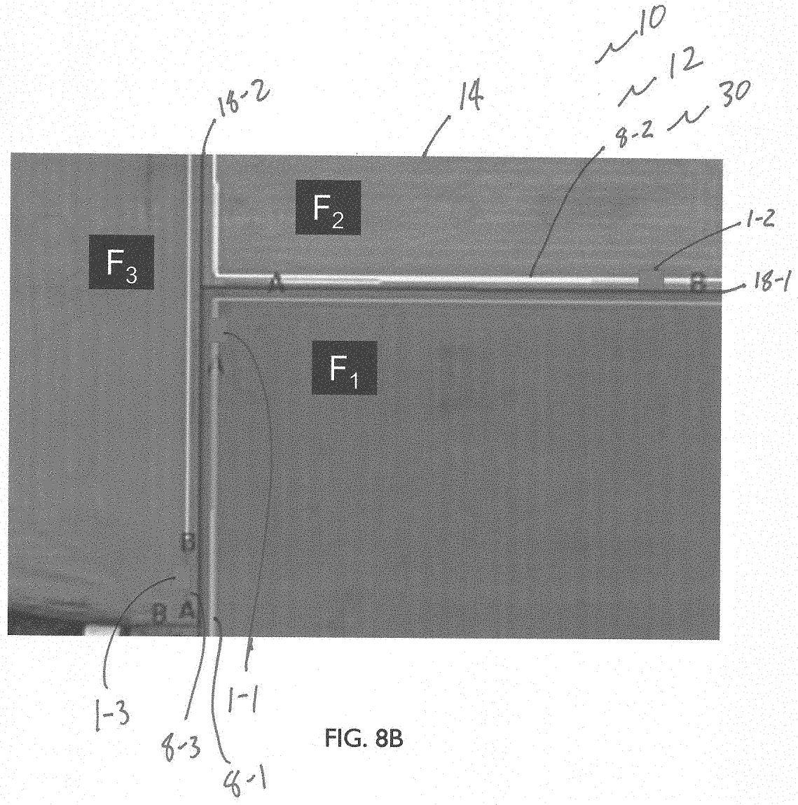

As shown in FIG. 2, in the optional field data input step (box 202) the path system 12 is configured to receive or retrieve one or more field data inputs and define one or more field boundaries and regions, such that one or more field characteristics such as a field map, field region, field boundary, and/or path data inputs are made into the path system 12 either by the user or from stored data, shown generally at box 202. In various of these optional sub-steps, an initial field or region map is inputted or otherwise defined (box 204). In a further optional sub-step, one or more boundaries are defined (box 206). In a further optional sub-step, an A-B line (box 208) is plotted or generated, as would be inputted by the user or retrieved from a database or enterprise system, as described below in relation to, for example, FIGS. 8-10.

It is readily appreciated that while the term “A-B line” is used herein to refer to a user defined starting path inputted into the system, the path data comprises offset, heading, and/or position information for the path, and can be of any shape, including paths that are straight, curved, or any other shape from a starting point (A) to an ending point (B). It is therefore appreciated that the A-B line data comprises offset, heading, and/or position information for the path along a user defined series of coordinates on the field map.

Continuing with FIG. 2, in a further optional step shown generally at box 210, one or more guidance paths are plotted (box 212) and displayed (box 214), which may comprise several iterations of potential adjustments via the various adjustment systems described herein before being finally plotted for use. According to these implementations, the system 10 implements iterative logic to plot and/or retrieve one or more guidance paths throughout the polygonal field map as dictated by the logic of the operations system 2 and the various user boundary and/or region inputs and/or path calculations performed in accordance with the known field data parameters of the field map shape, regions and/or boundaries established or retrieved at box 202.

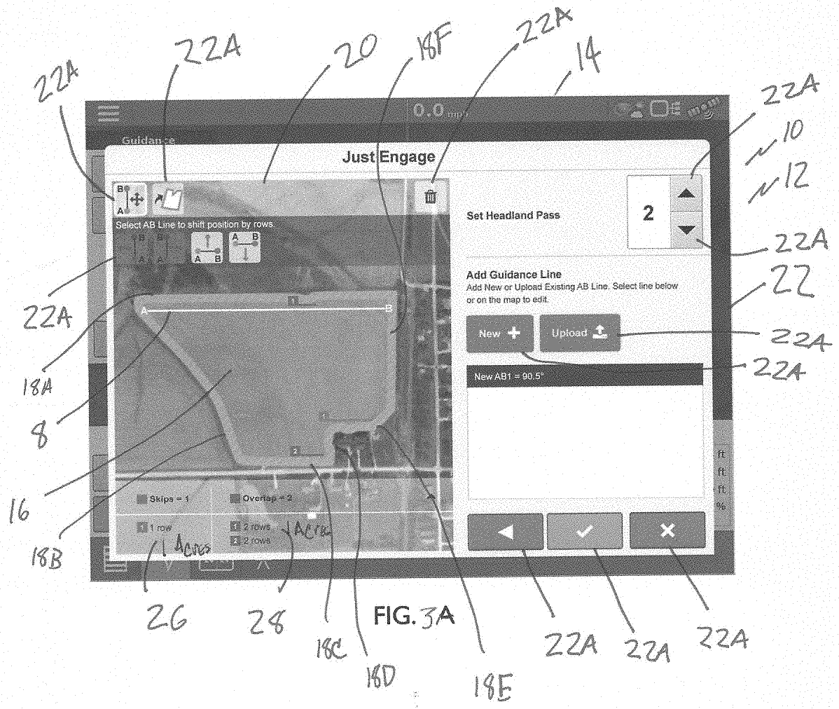

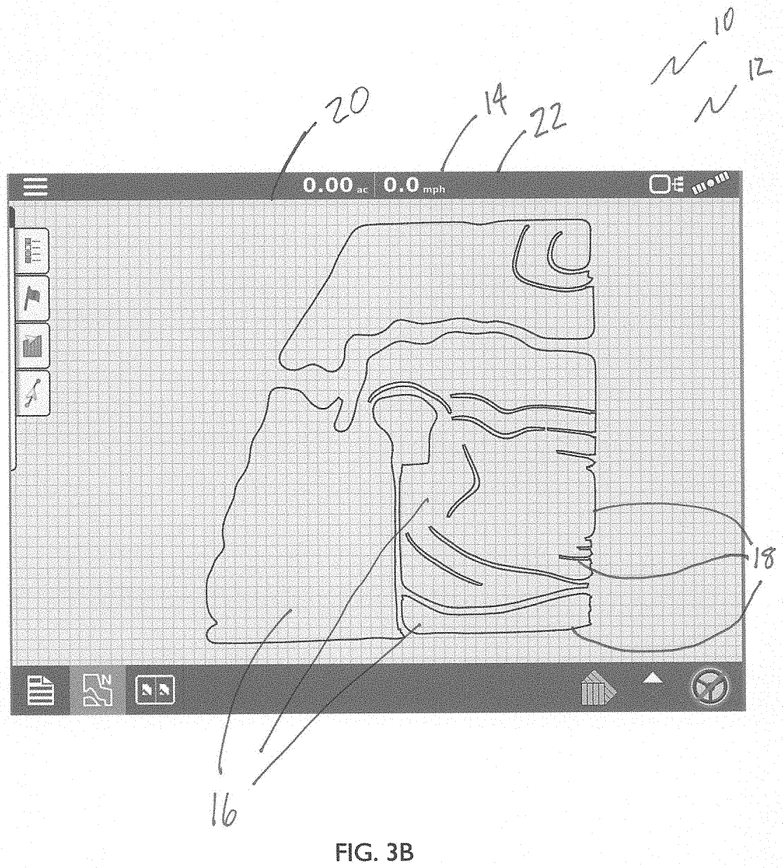

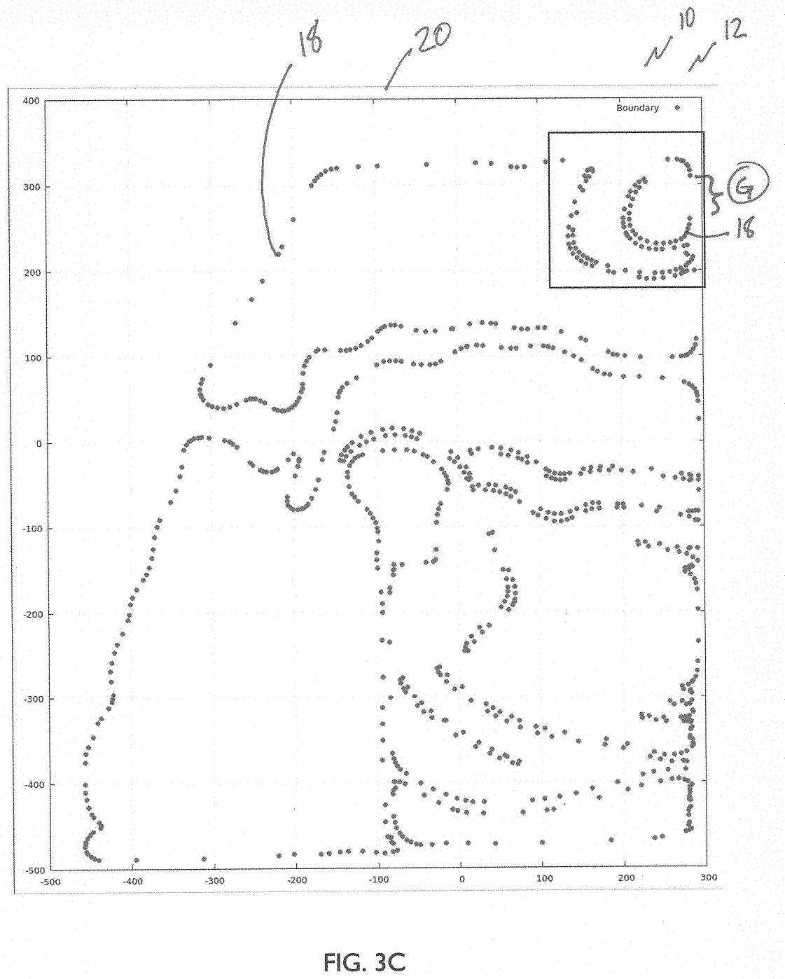

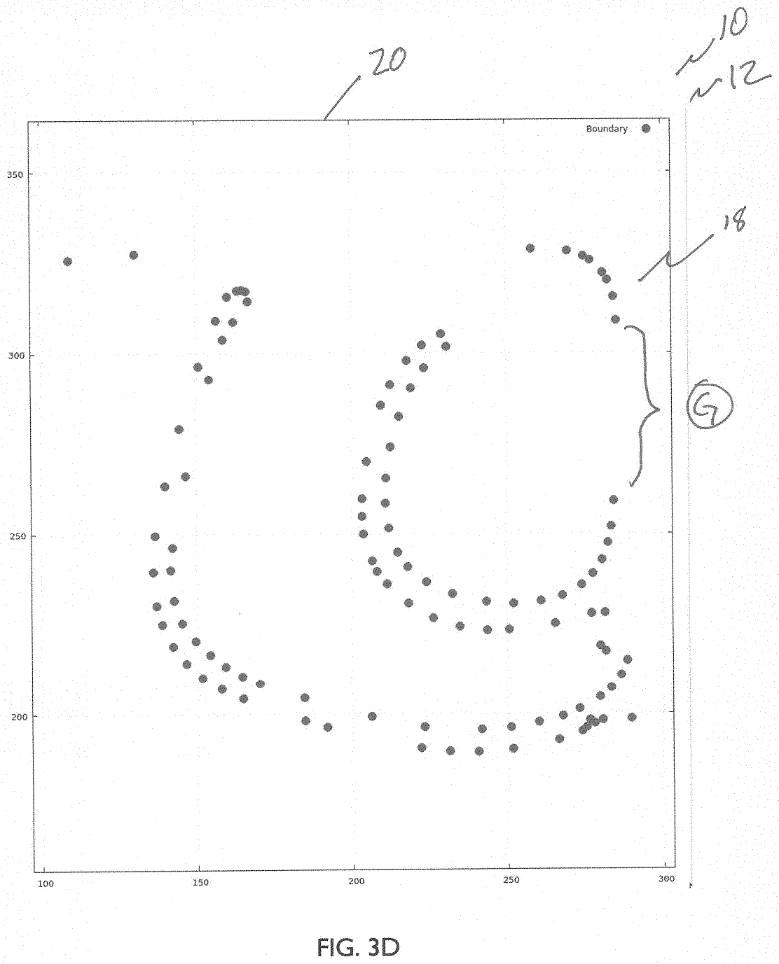

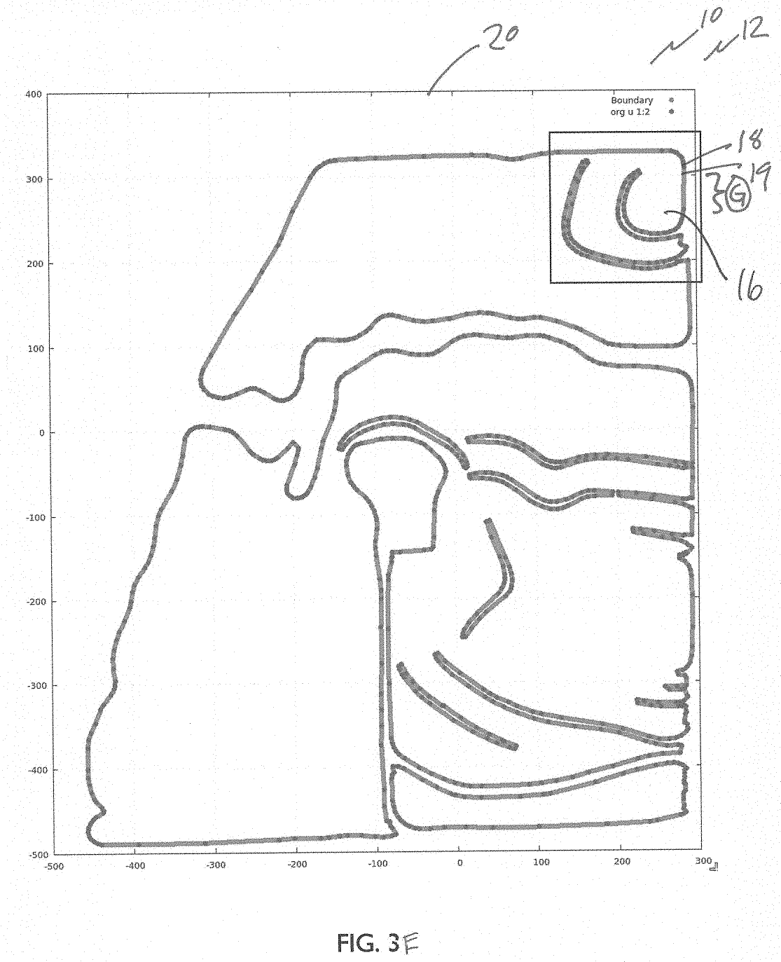

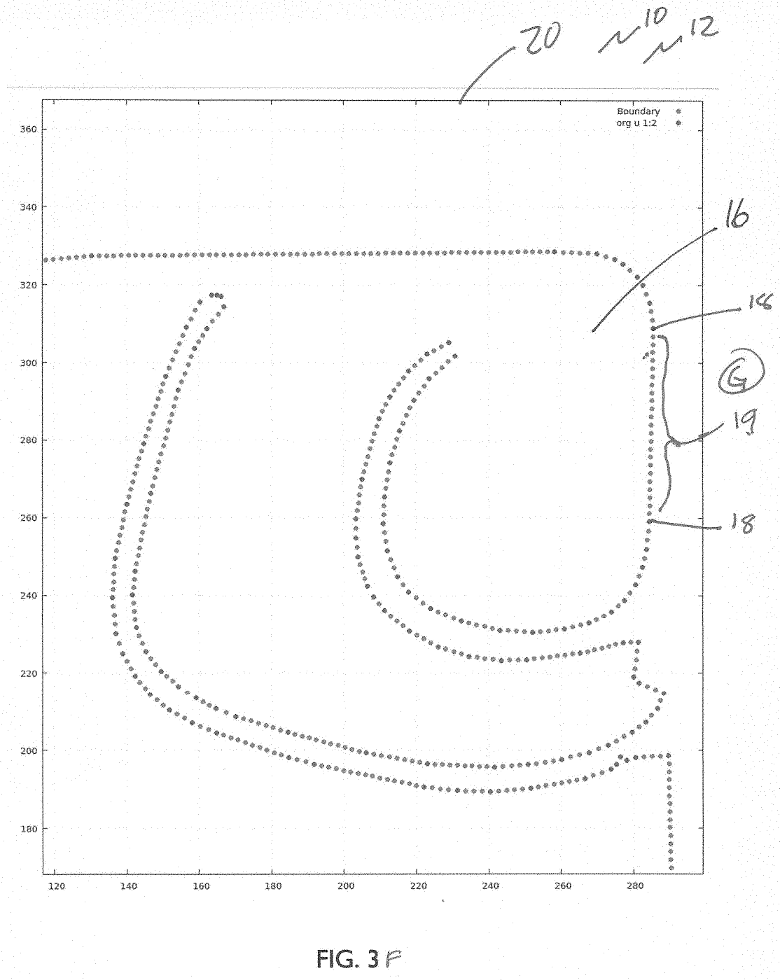

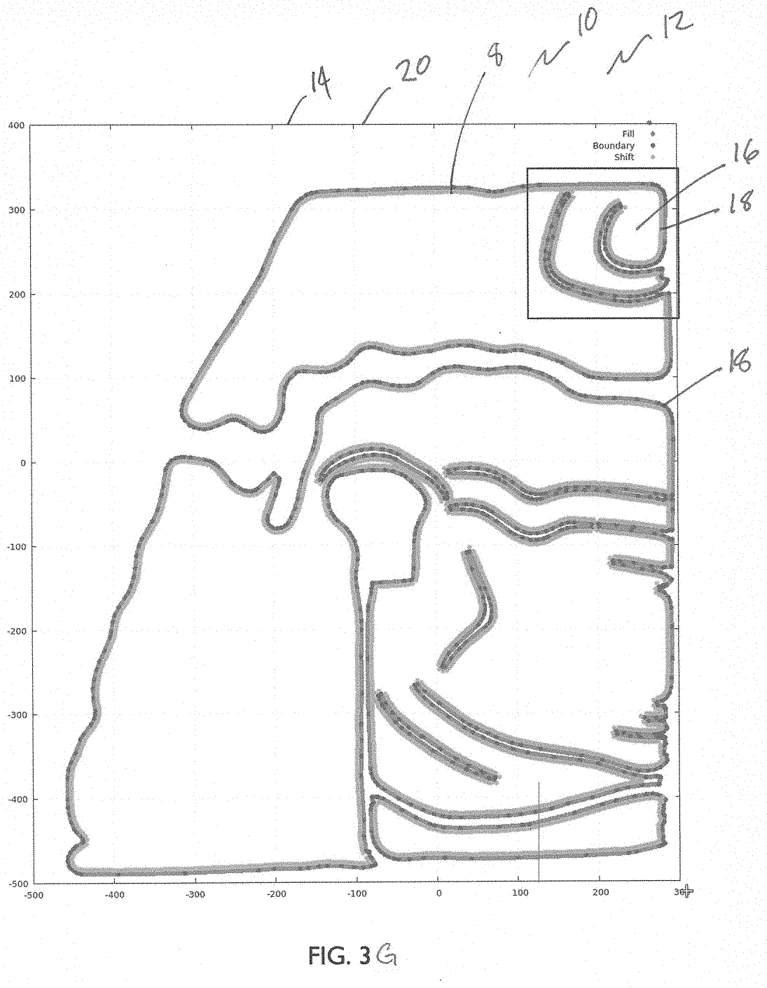

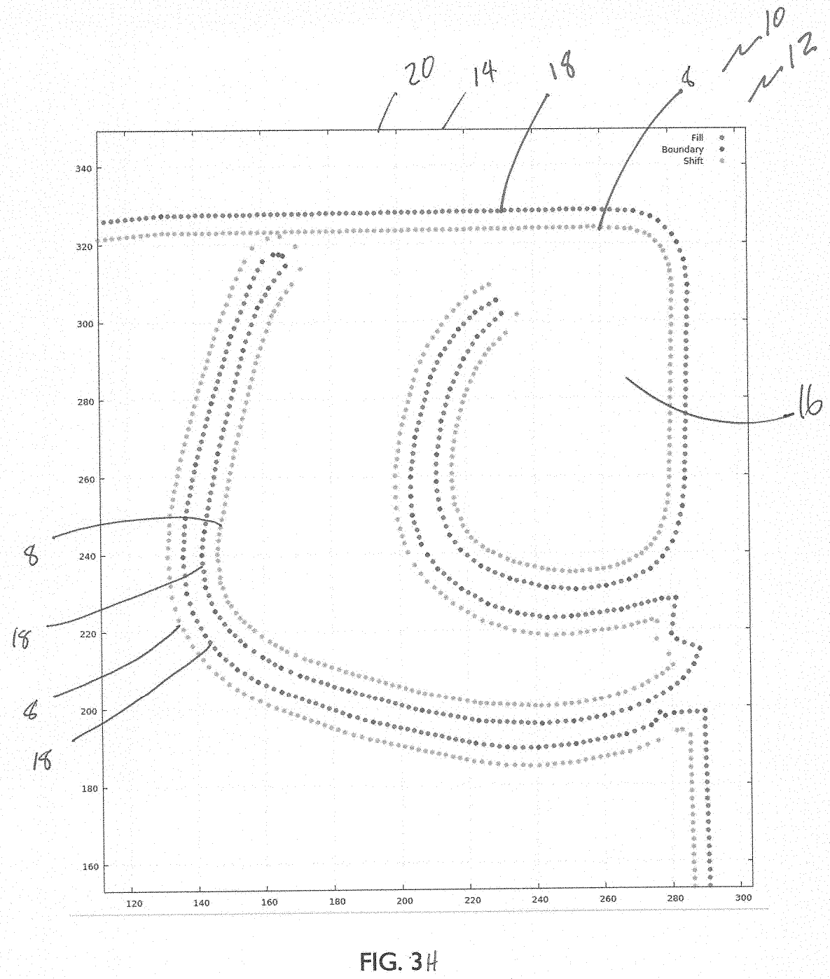

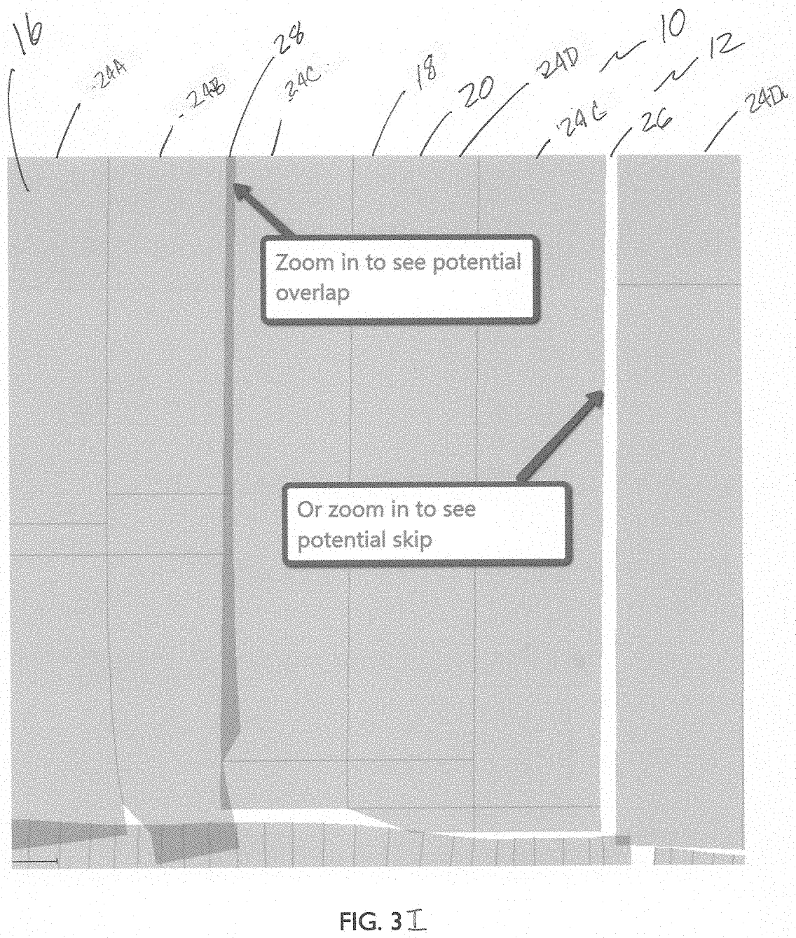

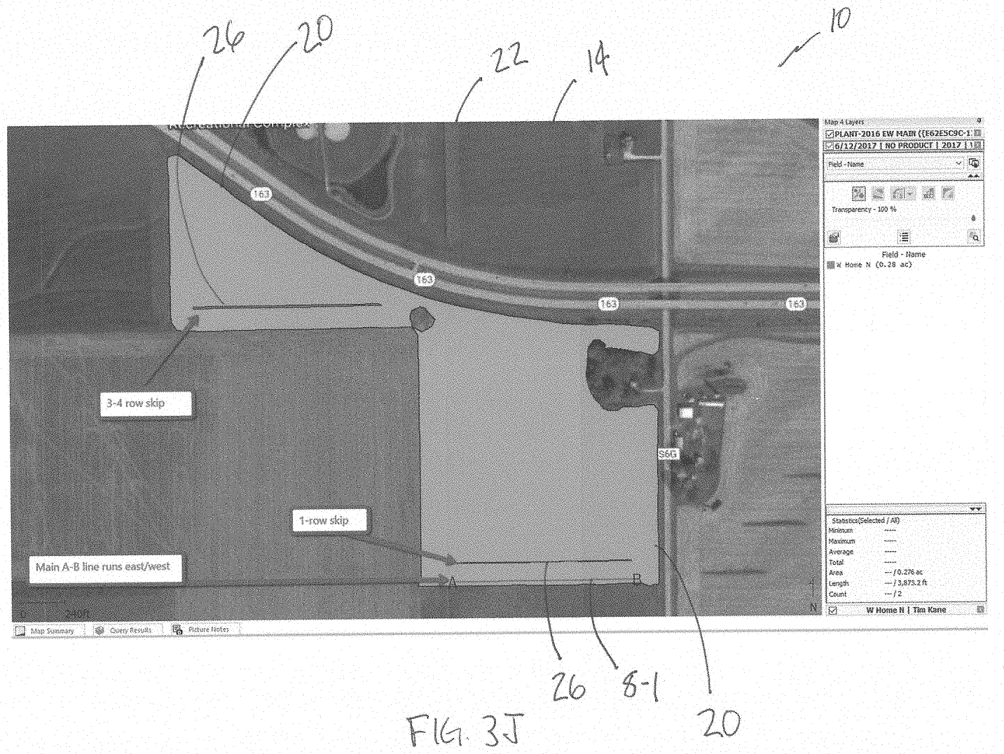

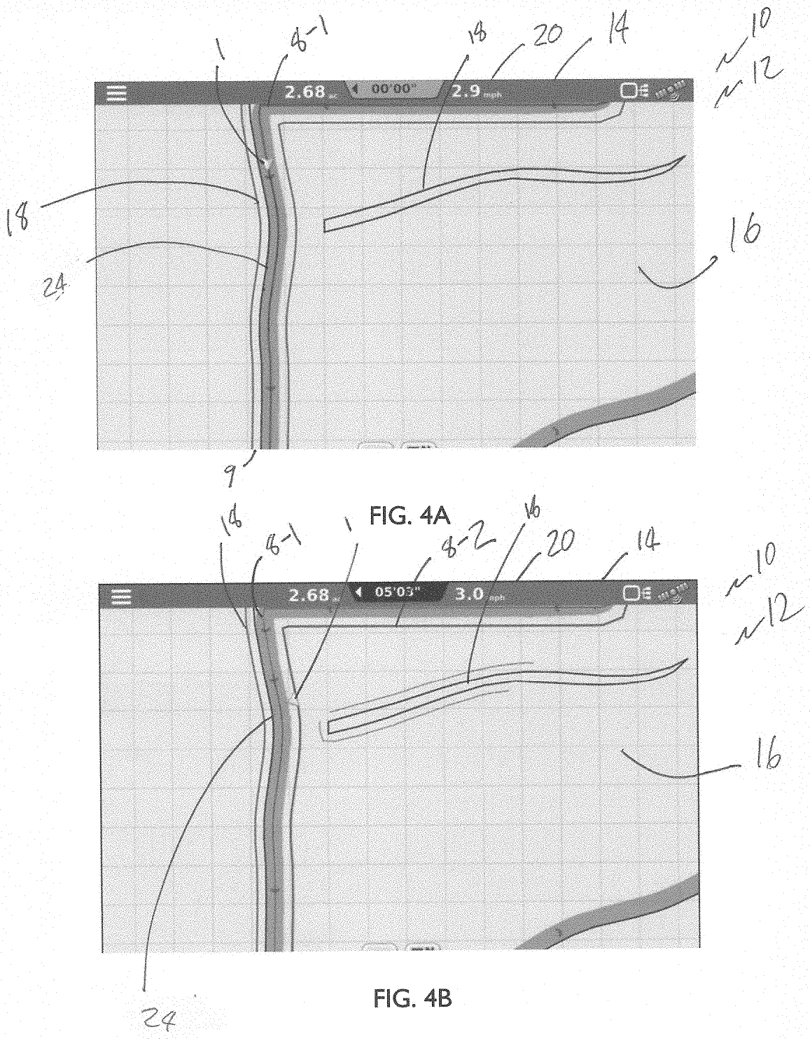

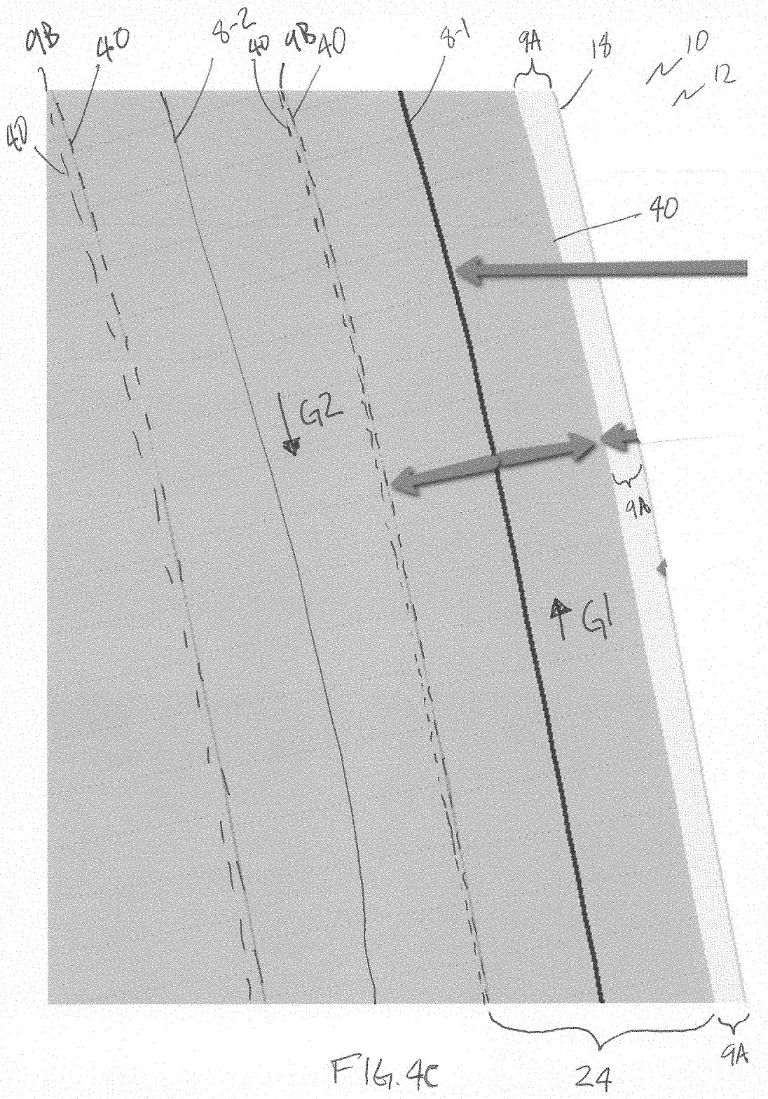

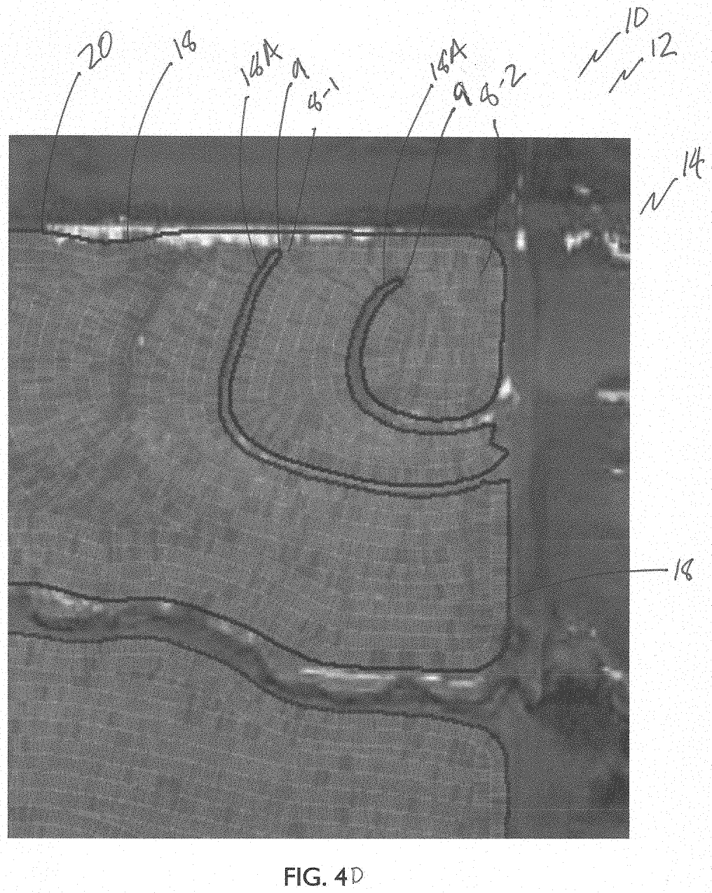

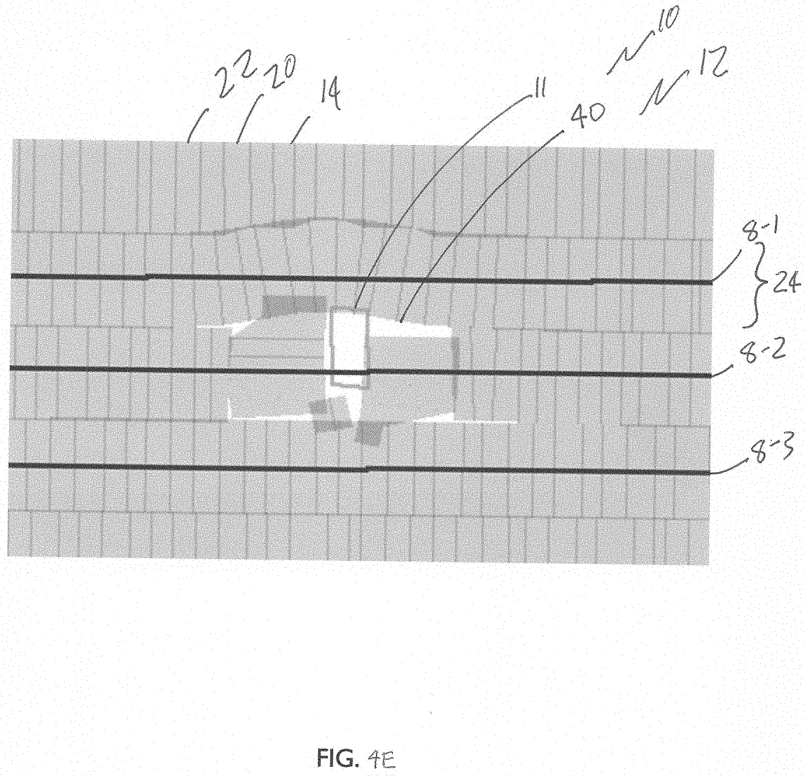

In various of these implementations, any defined user inputs relating to path position, heading, and offsets including tolerance preferences, such as to account for guess row width, defined boundary tolerances and the like discussed herein. That is, the plotting of the paths is performed on the basis of any of the defined user inputs discussed below in relation to FIGS. 3A-4E.

It is appreciated that as discussed herein, the paths can contemplate one or more of the swaths, swath edges and/or center implement guidance paths relating to implement heading and position throughout the field map, all of which would be readily appreciated by the operator and can be defined on the basis of the known characteristics of the vehicle and implement. For example, the path system 12 plots a swath that is about thirty feet wide when the operator has indicated to the system that a planter that is thirty feet wide is being used, with the center of the guidance path for the implement about fifteen feet from either edge.

It is therefore understood that the system 10 and path system 12 according to these implementations are configured to generate or plot initial guidance paths comprising position and heading data that can be visualized by the user for review and adjustment prior to engaging the automatic steering (boxes 212 and 214). In certain implementations, the heading, offset, and position of the guidance paths include the spacing between the plotted guidance paths.

As shown at box 216, in certain implementations, these paths are also able to be user adjusted via one or more of the defined offsets, shapes, automation and/or manual inputs according to the various aspects and features described herein before being finally plotted for output to, for example, the automatic steering unit for execution. In certain implementations, the operator approves the generated paths and engages the automatic steering. It is further appreciated that many or all of these adjustments can be displayed and or executed via the operations unit/display 14/GUI 22 and/or the other optional components described herein.

That is, in exemplary implementations of the system 10, the path system 12 plots one or more initial guidance paths and displays them to the user, such as with a prompt, and the user is then able to make one or more adjustments to the plotted guidance path(s) before engaging the automatic steering system, as shown in FIG. 1A and FIG. 1B. It is readily appreciated that various implementations contemplate situations in which the plotted paths in a particular region are adjusted while other plotted regions or paths are not adjusted. Further, as discussed herein in relation to the various examples, it is understood that the system 12 is displaying the plotted paths as a prompt to the user to adjust or confirm and engage the automatic steering unit.

In certain implementations, an optional path heading adjustment (box 218) is made, such as via inputs by the user to the GUI 22 buttons 22A, shown for example in FIGS. 3A-7. In various implementations, the path heading adjustment (box 218) revises one or more of the plotted paths through the region or field map(s) to alter the headings of the plotted path(s).

Additionally, in a further optional step that may be implemented via the GUI 22 and buttons 22A of FIG. 3A, an optional path position adjustment (box 220) is made to adjust the relative positions of the paths in terms of heading, path shape, path spacing (offset) and path position relative to one another as to spacing, angle and the like, as discussed below in relation to FIGS. 3A-7.

Additionally, in a further optional step implemented via the GUI 22 and buttons 22A of FIG. 3A, an optional offset adjustment (box 222) is performed to adjust any offsets applied to the guidance paths, including the distance between rows or paths as well as the distance from the edges of the paths to boundaries and the like.

It is understood that these heading, path, and offset position adjustments (boxes 218, 220, and 222) are performed concurrently or sequentially in various implementations to plot new path patterns throughout the field that have had heading, position, and/or offset adjustments. These adjustments result in the changes in direction, shape, and spacing of the plotted swaths throughout the region or field, as described in detail in relation to the implementations of FIGS. 3A-7, although many other examples are of course possible.

Continuing with the optional generation/adjustment/plotting steps (box 210) of FIG. 2, in a further optional step, an optional enterprise path adjustment (box 224) is made, such as from a cloud or enterprise command system, as described in relation to FIGS. 8-10 below. It is appreciated that such enterprise system commands can be used at various points in the process 200, such as in the adjustment of the paths and in the retrieval of field data and boundaries or generating initial A-B lines in relation to box 202 above.

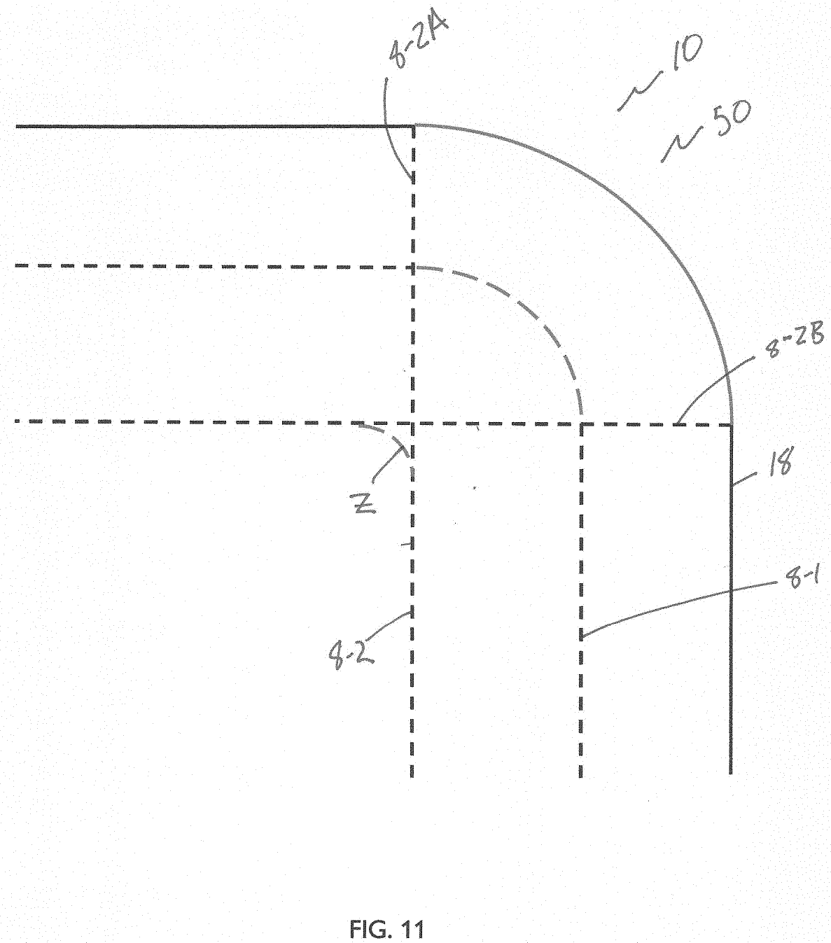

Additional optional process steps related to the optional generation/adjustment/plotting steps (box 210) include any optional squaring adjustments (box 226) made to the drawn guidance paths, as described below in relation to FIG. 11.

Continuing further with the system 10 process 200 of FIG. 2, after the paths are plotted, the system 10 optionally engages one or more commands or communications on the basis of the plotted paths, shown generally at box 230. In various implementations, the system 10 optionally stores (box 232) the plotted paths for later use and retrieval, such as on the operations system 2 or in the cloud 110, as discussed above in relation to FIGS. 1A-1B. In certain implementations, the system 10 optionally communicates (box 234) the plotted paths for use, such as through an enterprise path management system described in relation to FIGS. 8-10 below. That is, in addition to the cloud 110, path information can also be communicated between tractors and implements, as discussed in relation to FIGS. 8-10.

In exemplary implementations of the system 10, and as is also shown in FIG. 2, the process 200 includes optionally transmitting commands to an automatic steering unit or controller (box 236) for execution of assisted or automatic steering functions, such as have been previously described. As discussed above, one non-limiting example of a controller is SteerCommand®, though one of skill in the art would readily appreciate that many alternate controllers are possible, certain non-limiting examples including ParaDyme®, GeoSteer® and Ontrac3®.

FIGS. 3A-3G relate to implementations of the guidance system 10 having an automated visualization and path adjustment system 12, or path system 12, that is configured to automatically generate and plot guidance paths through a defined field map 20 for execution via the automatic steering unit 4 or other use, as described above in relation to box 230 of FIG. 2 and below in relation to FIGS. 8-10. In these and other implementations, the path system 12 operates in part via the in-cab display 14 showing the field map 20 on the GUI 22.

Importantly, it is appreciated that prior art guidance systems do not populate the entire field map 20 prior to the user initiating guidance and automatic steering, and that as a result the operator is unable to see, for example, where skips and overlaps will occur, or the number of paths that the operator will take or where they will end the field, among many other features described herein. It is further appreciated that the described innovations in the system 10 thereby provide the operator with numerous advantages by being able to plot and adjust the guidance paths throughout the field prior to initiating the guidance automation, which provides a technical improvement in these implementations and improves efficiency and productivity.

As shown in FIG. 3A, the GUI 22 can comprise one or more touch screen buttons 22A configured to allow the user to input various aspects related to the generated guidance path, such as defining A-B lines, creating new guidance path(s), uploading guidance paths to the cloud (shown in FIG. 1B at 110), defining field regions 16 or boundaries 18, and performing other necessary operations for the defining of parameters and plotting the guidance paths 8. Such data inputs can comprise adjustments, defined quantities and information related to both the guidance path(s) 8 and the total swath width (shown in the figures generally at 24) that will result from such guidance paths 8 implemented using the specific planter used with the implement, as would be understood.

That is, the system 10 is configured to draw wider width swaths 24 for wider planters, and correspondingly plot the guidance paths 8 accordingly. While this and other illustrative examples discuss the planting operation, it is readily appreciated that many field operations can be improved by the described implementations, such as spraying, fertilizing, tilling, harvesting, and the like. It is also appreciated that, as described herein, the path system 12 can in certain implementations generate initial guidance paths 8 for display on the display 14 that can be iteratively adjusted via the various adjustments discussed herein for plotting of the guidance paths (generally at 8) eventually plotted and used by the tractor/operator on the basis of a number of factors including the non-limiting examples of overlaps and skips between swaths including the quantity and/or area of any such skips or overlaps.

As is also shown in FIG. 3A, the GUI 22 is configured to depict one or more field maps 20. It is understood that the field map 20 can be defined as any polygon having three or more sides and representing an actual field to be planted, and can comprise one or more polygonal regions 16 that will be populated with guidance paths 8 throughout according to the various user defined offsets and adjustments described herein that can modify the offset, heading, and/or position of the guidance paths 8, as discussed in FIG. 2 at boxes 218 and 220. That is, it is further understood that real-life fields are rarely perfect rectangles, they have irregularities, and as such there may be several areas of the field that do not cleanly correspond to a perfectly linear plotting of guidance paths 8. Instead, the guidance paths 8 in any individual field 20 and region 16 may vary in offset, heading and/or position as well as pattern, as described herein. It is also appreciated that when planting a polygonal field map 20, there are gaps and overlaps, even when planting in parallel paths.

Accordingly, as shown in FIG. 3A, the path system 12 according to certain implementations, allows the user to define, download, or plot one or more A-B paths 8, regions, 16 and/or boundaries 18A, 18B, 18C, 18D, 18E, 18F within a field map 20 displayed on the GUI 22. It is understood that these initial A-B paths 8, regions 16 and/or boundaries 18A, 18B, 18C, 18D, 18E, 18F can be drawn manually in certain implementations, and then the path system 12 is able to automatically generate further paths within the defined field region(s) 16 and boundaries 18A, 18B, 18C, 18D, 18E, 18F according to the parameters defined in the path system and any corresponding adjustments.

It is further understood that in various implementations of the system 10 applied to any polygonal field map 20 comprising one or more polygonal regions 16, the boundaries 18 discussed herein can be defined from stored field maps or be drawn by the operator, such as through driving an initial manual outer path around a field, which can be both used and stored by the system 10, as would be understood. Further, it is appreciated that the various boundaries discussed in the present disclosure can include various features of the field regions 16 as well, such as waterways and terraces as well as obstacles and other features that the operator seeks to avoid or otherwise pilot around. It is further understood that the system 10 according to certain implementations will use a combination of the disclosed technologies to plot the guidance paths 8 relative to the boundaries 18 in the various field regions 16 such that the guidance paths 8 for a given field region 16 can form a polygon that is used to define a boundary 18 in another field region 16, as would be readily appreciated by those of skill in the art.

FIG. 3B depicts several defined regions 16 and boundaries 18 utilized by the path system 12 to plot guidance paths 8. It is understood that in various implementations, the user can define these regions 16 and/or boundaries 18 through the GUI 22, they may be generated or populated by the system 10 on the basis of stored field map 20 data or they may be generated on the basis of manually-driven paths and GNSS data, as would be appreciated. Accordingly, these implementations of the system 10 utilize defined boundaries 18 and regions 16 derived from a variety of appreciated sources to populate the guidance paths 8 through the field map 20 according to certain defined user inputs and stored values to maximize the efficiency. Further, in the various implementations, operator input can be used to reflect various preferences to improve the efficiency of the plotted lines according to the skill, preference, and experience of the operator.

However, as shown in FIGS. 3C-3D, boundary files frequently comprise a series of recorded points (shown generally at 18A) with interspersed gaps (such as is shown at G) rather than continuous lines. It is appreciated that large gaps between the recorded points can frustrate guidance path generation.

Accordingly, as shown in FIGS. 3E-3F, in implementations utilizing stored boundary files for defining the boundaries 18, the path system 12 is configured to populate the boundary 18 with additional points to render a best-fit line (shown generally at 19) so as to smooth the boundaries 18, reduce the distance between the plotted boundary points and allow the path system 12 to plot guidance paths within the defined boundaries 18, as would be appreciated.

In the implementations of FIGS. 3G-H, after the boundary 18 has been established for the desired regions 16, the path system 12 is able to utilize the known width of the planter swath to draw an initial guidance path 8 inside the boundary 18. It is appreciated that the planter width can be user defined via input into the operations unit 2 or stored, as would be appreciated, and that the drawn guidance path 8 can be done based on a calculation of half of the width of the swath plus any defined, default or user-inputted buffer. So for example, for a planter with a swath that is thirty feet wide, the guidance path 8 can be drawn according to a user defined boundary offset 9, for example fifteen feet, inside the region 16 from the boundary 18, plus or minus any offset tolerance that is set by default or that is entered into the system 12. That is, the additional tolerance may be defined as an additional foot of space to account for any obstacles or misalignments that may occur and to prevent any mistakes in planting or damage to equipment, as would be readily appreciated.

In these and other implementations, after the initial A-B path 8 or paths 8 are entered manually, generated from the various boundaries 18, the path system 12 then auto-populates additional guidance paths 8 to the defined region(s) 16 of the polygonal field map 20 according to any specified or defined terms and characteristics to maximize field coverage and, for example, minimize skips 26 and/or overlaps 28 between planted rows, which can be shown in greater detail on the display 14, as shown in FIGS. 3I-3J. In various implementations, the system 10 is able to adjust the path position(s), heading(s), and/or offset(s) to achieve optimum coverage (shown in FIG. 2 at boxes 218 and 220).

It is likewise understood that in certain implementations, data relating to the plotted A-B paths 8 can be stored, such as in the cloud (shown in FIG. 1B at 110), and measured, such as against yield, to establish efficiency and improve guidance in subsequent years and between fields, as would be appreciated. Further, certain implementations utilize machine learning and/or other artificial intelligence techniques or algorithms to provide users with suggested paths 8 via the path system 12. In certain of these implementations, the path system 12 plots coverage having the fewest number of total swaths and/or turns. In various implementations, the user is then optionally able to manually adjust one or more of the plotted paths 8 to fit individual circumstances through the path system 12, as would be readily appreciated. Such inputs into the path system 12 and manual adjustment can of course be implemented via the display 14, GUI 22, buttons 22A, or other understood input mechanisms, of which there are many.

Continuing with the implementations of FIG. 3A-3J, by using a defined region 16 or boundary 18, such as the field boundary 18 or outside headland pass(s), the path system 12 visually indicates to the machine operator where they may have skips 26 or excess overlap 28 in number and/or area, based on populated guidance swaths 24A, 24B, 24C, 24D, 24E, 24F, as shown for example in FIG. 3I-3J.

Accordingly, in use, the operator in these implementations is able to zoom in on the display 14/GUI 22 to see a larger map 20 view, like that shown in FIGS. 3I-3J, where the skips 26 and/or overlaps 28 in the swaths 24A, 24B, 24C, 24D, 24E, 24F are shown in detail on the display 14 such that the user is appraised of the currently routed guidance through the field and can, at their option, make adjustments to the guidance paths 8. Further implementations enable the ability to zoom in and see each of the projected paths 8, the full width of every path and the path direction. Further implementations are of course possible.

FIG. 4A depicts a guidance path 8 and swath 24 drawn in a field region 16 via the determined boundary 18, as discussed in relation to FIGS. 3G-3H. As is shown in FIG. 4A, the implement 1 is being routed down the guidance path 8 which is spaced from the boundary 18 to account for the width of a half swath 24 plus any adjusted, defined or default offsets, shown for example in FIGS. 4A and 4D at 9.

In FIG. 4B, another guidance path 8-2 has been drawn inside the region from the first path swath 24A, again on the basis of the defined swath width plus any defined offset(s) 9 such as a headland pass or guess row length, or the other defined offsets 9 and/or tolerances discussed herein. That is, in these implementations the subsequent guidance path 8-2 is drawn by the system 10 by accounting for the outer edge of the previous swath 24A.

FIGS. 4C-4E depict various implementations of the system 10 and path system 12 illustrating uses to account for field characteristics and user preferences by adjusting the heading, position, and/or offset of the guidance paths.

In the implementation of FIG. 4C, the system 10 generates a first guidance path 8-1 from the boundary 18 by summing half of the swath 24 width) with a boundary offset 9A. So, for example, for a planter that is thirty feet wide, the swath width is about thirty feet. With a boundary offset 9A of three feet, the guidance path 8-1 would be plotted at a distance of one half of the swath width (about fifteen feet) plus the boundary offset 9A (three feet) for a total of about eighteen feet from the boundary 18. Further, a guess row offset 9B can also be utilized between the paths 8-1, 8-2. It is appreciated that the positions of the paths 8-1, 8-2 and headings G1 and G2 are also plotted and can be adjusted, as discussed herein. Further examples are of course possible.

In the implementation of FIG. 4D, guidance paths (shown generally at 8) have been drawn around on the basis of a number of field boundaries 18, including terraces 18A. It is appreciated that in these implementations, the system 10 allows the user to define an offset 9 distance to address the desired path offset from a terrace 18A. It is appreciated that such offset 9 distances can be defined and varied for given field boundaries 18, 18A or obstacles (shown, for example in FIG. 4E at 11) in various implementations. Further, as another example, under certain implementations of the system 10 the user is able to use an offset 9 to align the implement with, for example, the top of a farmable terrace to account for row unit flex on the toolbar of the implement. Further implementations are of course possible and would be appreciated.

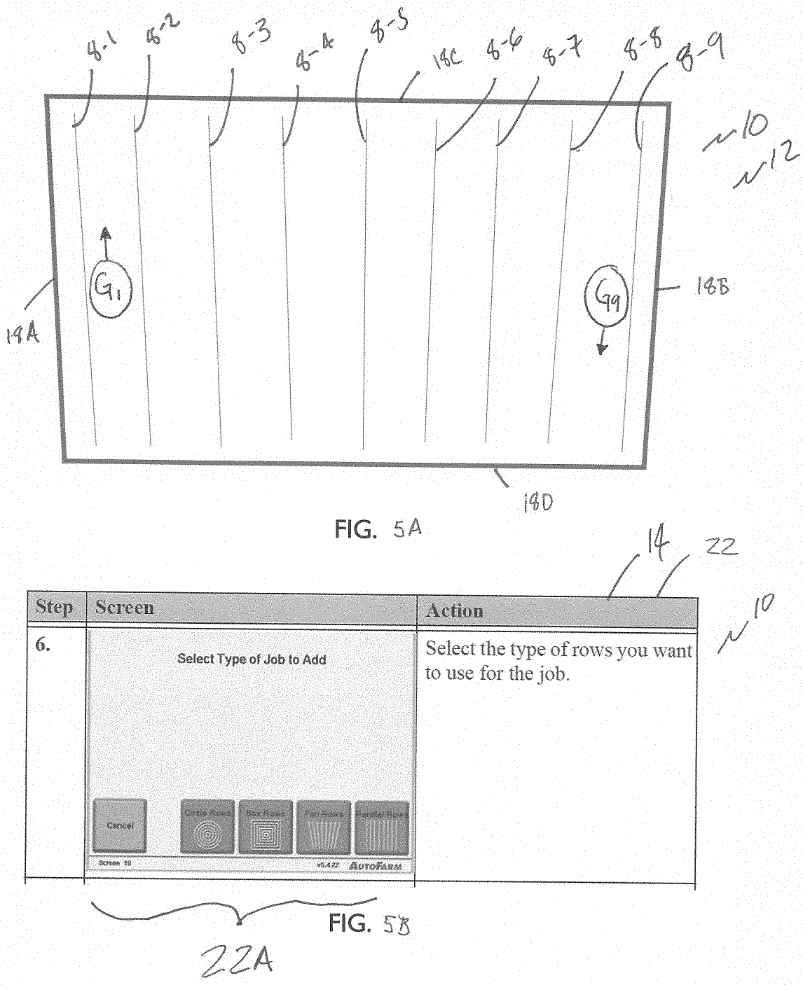

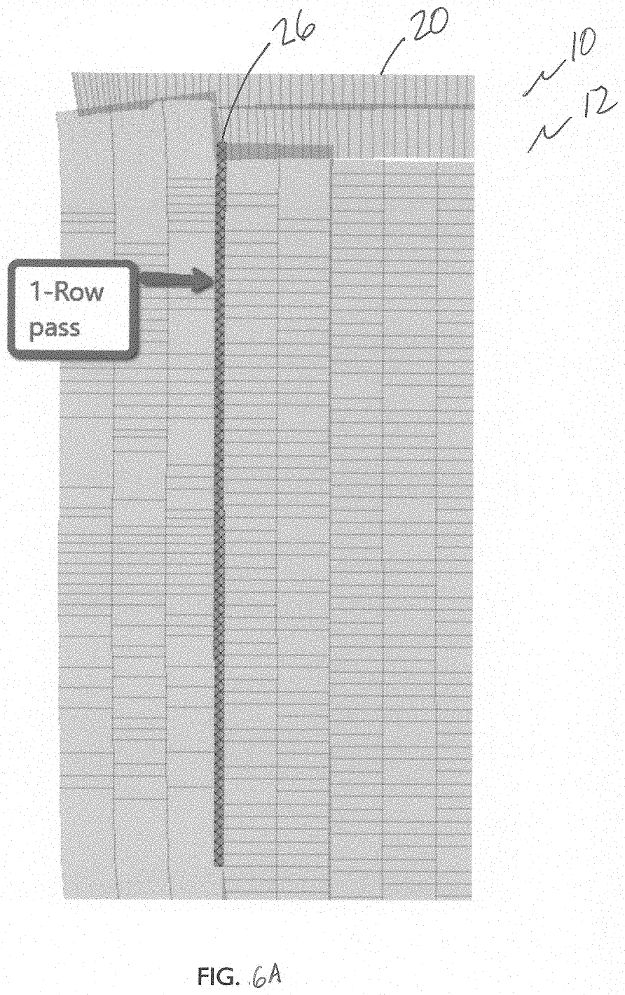

As shown in FIG. 4E, on the basis of the guidance paths 8-1 and swaths 24 the user is able to visualize where the outer edges 40 of the implement—such as a planter or sprayer boom—will be relative to obstacles 11 in the field such as tile intakes, power poles and the like. Accordingly, in these implementations of the system 10, it is easier for the operator to maneuver around these obstacles 11 when the guidance paths 8-1, 8-2, 8-3 are plotted such that the obstacle aligns with these outer edges 40 of the implement width, as would be readily appreciated. Many other advantages are inherent to the improved visualization provided by the system 10. In one illustrative example shown in FIGS. 5A-5B, the system 10 guidance path system 12 is configured to adjust A-B guidance paths 8-1, 8-2, 8-3, 8-4, 8-5, 8-6, 8-7, 8-8, 8-9 on each subsequent path in order to optimize the paths such that the first guidance path 8-1 path and last guidance path 8-9 path are parallel to their respective boundaries 18A, 18B of the field map 20.

That is, for example, where a field map 20 requires one hundred paths to plant and is four hundred inches wider at one end than the other, the system can adjust the path offsets, positions and/or headings so as to “fan” the planted rows such that they are about four inches further apart at the wide end, such as via the buttons 22A on the GUI 22 in FIG. 5B. It appreciated that many such adjustments are possible, and that myriad row configurations are possible, such as circle rows, box rows, fan rows, parallel rows and the like, and that in each case the path system 12 displays the plotted swaths to the user for adjustment of the swath position, heading and offsets, as described above in relation to FIG. 2.

It is appreciated that the offset adjustments can vary between the plotted paths, such that a first offset may be applicable to a headland pass row, while another offset may be applicable to guess rows and a further offset is applicable to terraces. Many examples would be appreciated and several are described elsewhere herein.

It is readily appreciated that in these examples, in addition to offset, the guidance path position(s)/heading(s)/offset(s) are altered on the basis of user input and adjustments, and that the guidance paths 8, swaths 24, and edges 40 are subsequently plotted for the field map 20 as would be readily appreciated. In so doing, it is appreciated that the various headings G1, G9 are not necessarily linear vectors, but can alter in direction between and for each individual guidance path 8. That is, G1 is not necessarily a fixed heading throughout a row, nor is G1 necessarily parallel to G9, and so on, as would be readily appreciated.

That is, the system 10 according to the guidance path system 12 implementations begin with a given A-B path 8-1 that is parallel to a boundary set by the initial boundary 18A of the field map 20 or any manually-driven outside path, as described above. As paths 8-2, 8-3, 8-4, 8-5, 8-6, 8-7, 8-8, 8-9 are propagated across the field towards the ending boundary 18B, they may be adjusted in one or more ways, as follows.

In certain exemplary implementations, the guess row swath distance between paths 8-1, 8-2, 8-3, 8-4, 8-5, 8-6, 8-7, 8-8, 8-9 can vary by adding or subtracting a user defined distance. For example +/−about 2 inches. As such, if the row width is 30 inches, the space between the swath from the first path and swath from the second path could be 28-32 inches.

As such, the path system 12 according to certain implementations in response to user preference input by varying the position(s)/heading(s) and/or offset(s) of subsequent paths 8-2, 8-3, 8-4, 8-5, 8-6, 8-7, 8-8, 8-9 as they are propagated across the field, such as in response to input via the GUI. For example, in response to a user-inputted adjustment relating to the shape of the rows, the initial path along the initial boundary 18A at the first side of the field may be at about 180 degrees, the second at about 180.5, the third at about 181 and so on until the final path along the ending boundary 18B is at 190 degrees with is parallel to the ending side of the field. It is appreciated that the position, heading and offsets of the plotted paths 8-1, 8-2, 8-3, 8-4, 8-5, 8-6, 8-7, 8-8, 8-9 are thereby adjusted for review and confirmation prior to engagement of the assisted steering unit.

Various implementations of the guidance path system 12 optimize the paths 8-1, 8-2, 8-3, 8-4, 8-5, 8-6, 8-7, 8-8, 8-9 to a full swath-width path on the ending boundaries 18C, 18D of the field, as would be appreciated.

As discussed above, many agricultural fields are not actually square, which can result in several last row challenges addressed by the system 10. In various implementations, the system 10 allows the operator to view irregularities in the last row to make management decisions prior to beginning the field. For example, in various implementations the system 10 displays to the user one or more of the position, offset, heading, and end point of the last row such that the user is able to make any modifications to improve efficiency, such as altering the last row to end at the field entrance or choosing to skip the last row if only a portion of the rows will be needed. For example, if the last row will only result in the planting of three additional rows in a portion of the field and end at the opposite end from the entrance, the user may elect to bypass the last row or adjust its offset, heading and/or position to more efficiently exit the field or maximize coverage. Myriad examples are possible.

It is appreciated that these implementations represent a technical improvement by allowing the generation of a set of paths 8-1, 8-2, 8-3, 8-4, 8-5, 8-6, 8-7, 8-8, 8-9 that adjust path offset width, position, and/or heading in order to become parallel the various sides or boundaries 18A, 18B of a field instead of one, thereby eliminating point and fill-in rows on the ending sides of the field or region.

As discussed above, additional implementations of the path system 12 are configured for on screen adjustment of the guidance path(s) 8 and visualization updates in real-time via the GUI 22, such as via the plurality of buttons 22A. Various implementations optionally allow for the defining or recommending start and stop points (shown generally at A and B) to maximize efficiency and proximity to entry/exit points, as would be readily understood by those skilled in the art. Various implementations also optionally include the ability for shifting a guidance path 8 to adjust the path position(s)/heading(s)/offset(s) to determine ideal guess row paths. That is, optionally, by altering the A or B points and/or adjusting the position(s)/heading(s)/offset(s) and other variables as would be understood via the GUI 22/buttons 22A.

Additional implementations can include adjustments to the position(s)/heading(s)/offset(s) to achieve the effects of fan rows, or un-evenly spacing throughout guess rows and take into account access paths, and the ability to visualize paths from future operations—for example spraying and harvest—to better optimize one operation for a subsequent operation, for example planting and subsequent harvesting.

It is appreciated that a sixteen-row planter is typically harvested with two paths of an eight-row corn head. It is a significant waste of time to have to harvest a single row or two rows on the opposite side of the field. As such, the plotted guidance path logic can include information about harvester characteristics that can inform the path system 12 in plotting the guidance paths, as would be readily appreciated.

Additional implementations can include various additional features, such as presenting calculations of total overall overlaps or skips and/or an area total of the projected overlap or skips, including areas covered by the swath of the machine, but those rows were not active because the area had already been covered. Further implementations visually indicate the smallest width swath and/or longest path via the display 14, as discussed above in relation to FIGS. 3A-4D.

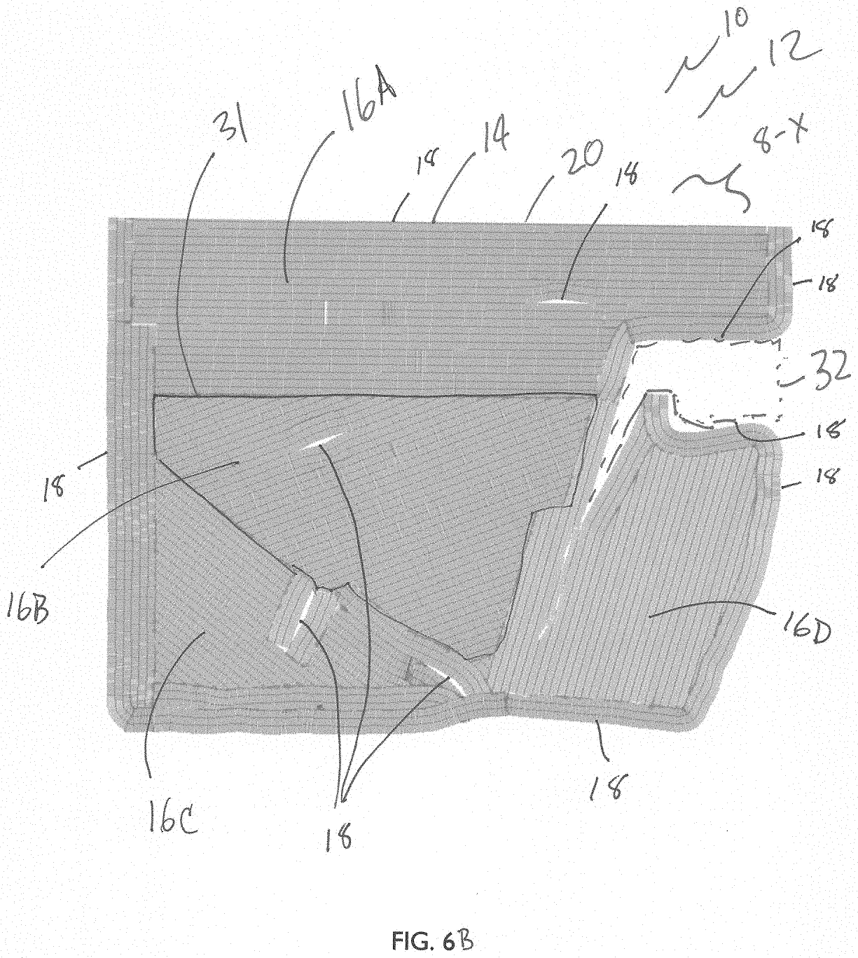

As also discussed above, certain implementations automate various aspects of guidance path 8 generation through the path system 12. For example, the user may want to offset their guidance path 8 before beginning the field so that they do not leave a one row “skip” 26 that would need to be covered by the planter where only one row would be active (one row out of twenty-four), as is shown in FIG. 6A.

Certain implementations also feature a skip tolerance, a user defined or stored value which indicates to the system 10 that a row skip 26 of the defined number value is acceptable to the user. For example, the user can define the skip tolerance as any of zero or one or more rows such that the system 10 will generate paths 8 that efficiently allow for the defined skip tolerance or fewer rows that will be skipped, as would be readily appreciated by the skilled artisan. In certain implementations, these skips 26 can be indicated using an alternate color on the map 20, as would be readily appreciated. Again, the operator is then able to make a decision as whether or not to move a guidance path 8 or not via the path system 12.

Multiple guidance paths can be provided in a single region 16A, 16B, 16C, 16D or field 20, as shown in the implementation of FIG. 6B at 8-X. Further, certain implementations are configured for the ability to enter stop points (illustrated at the polygon at 31) or otherwise communicate to the system 10 that a guidance path 8 has changed, such that the system 10 can adapt to user input. In certain examples, the user can draw a polygon 32 or other shape on screen to limit a guidance path generation area within the system 10, such as by defining specified boundaries (shown generally at 18) around and/or within the specified field map 20 and regions 16A, 16B, 16C, 16D.

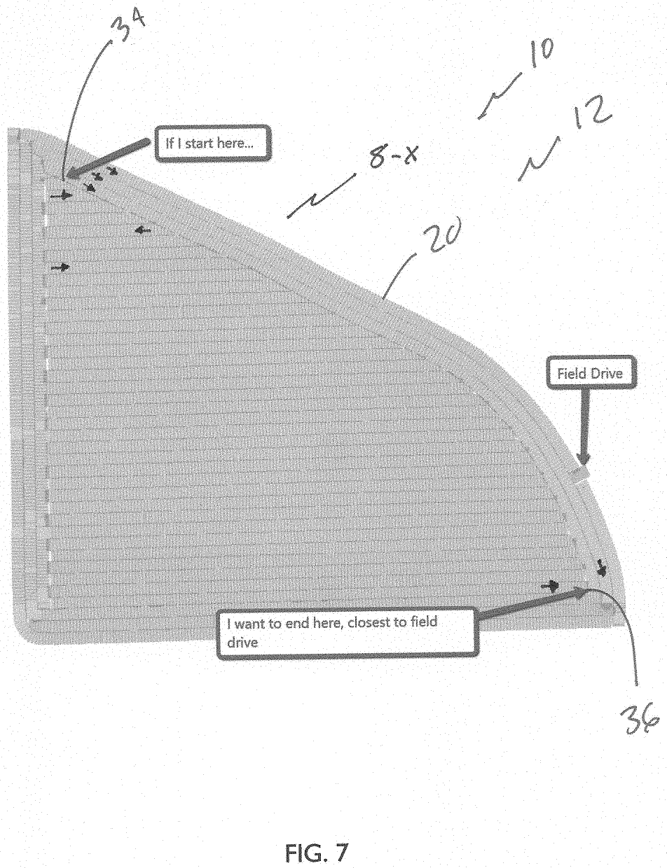

Certain implementations of the guidance system 10 allow the user to visualize the heading the tractor could or would be facing on each successive path, as shown in FIG. 7 at the start 34 and end 36. It is appreciated that displaying the headings allows the operator understand and make changes to what end of the field they will finish on. This also helps predict where the operator will be throughout the field, such as at certain benchmarks, which can be used to, for example, be best positioned to fill with additional product when needed and have information about how many paths may be left to finish the field in real time.

In example shown in FIG. 7, an operator may want to start at the start 34 of the field 20 where the rows are short but end on the long rows with the machine heading the correct direction, offset and position on the final path to end 36 where the field drive is located. Those of skill in the field would appreciate that many other examples and implementations exist in certain circumstances. It is appreciated that in certain implementations, such as those used with an implement that is ninety feet wide, the guidance paths may include several swaths.

Additional implementations allow for the calculation of various estimates, certain non-limiting examples being the amount of time or number of paths remaining, the number of skips/overlaps and the total area covered by skips/overlaps, though one of skill in the art would appreciate further calculations that can be made. Through use of enhanced logic, the path system 12 provides the user an estimated number of paths, the current productivity, such as in acres/hour, and/or the time remaining to complete the field. The path system 12 can calculate how long an average path takes to complete and now many paths are remaining and how long it takes for machine to turn around on headlands.

The path system 12 also represents a technical improvement by reducing the need to take extra path(s) across the field for perhaps only a small portion of their implement, which is inefficient. Today users can try to lay this out in geospatial mapping software such as Ag Leader SMS Software, but time consuming, not convenient, and far too difficult for the majority of farmers/dealers to do. As such, the path system 12 represents a technical improvement over the art.

It is thus understood that these implementations also help avoid making an “empty” pass across the field, which happens when the last path is completed on the side of the field opposite the entrance/exit. It is understood that this can increase efficiency, allow users to finish fields faster, improve making the small paths (in planting and then additional operations) and lead to less compaction of the soil.

Continuing on to the implementations of FIGS. 8A-10, further implementations of the guidance system 10 comprise an enterprise management system 30. The management system 30 is constructed and arranged to provide users with guidance paths so as to operate the guidance system 10 for consistency in path amongst adjacent rows of multiple fields.

That is, it is understood that a challenge farmers face today across their full enterprise is having perfect or even acceptable fence path borders between adjacent fields. For example, in certain fields farmers plant both corn and soybeans, as is understood. Other fields border a neighbor, for example, or the farmer may farm both fields but they are managed independently, such as by different entities.

It is further understood that increasingly, fence lines are being removed so that trees and weeds do not grow up in this space. Instead, the fields are farmed with row crop crops immediately adjacent to the field border. As a result, the rows in field F₁—which are normally about thirty inches apart from neighboring rows within the same field—should be about thirty inches away from the rows in neighboring fields F2 and F3, as shown in FIG. 8A.

Accordingly, FIGS. 8A-10 relate to implementations of the system 10 featuring such management systems 30, which as described in relation to FIG. 2 can be operationally integrated with the path system 12 at various optional input, calculation and output steps.

Today most farmers just estimate an edge of the field and correspondingly where to plant the outside path. Through use of the disclosed management system 30, a user is able to engage the implement 1 auto-steer system along these field borders via A-B guidance paths 8-1, 8-2, 8-3 as shown in FIGS. 8A-8B. That is, the enterprise management system 30 is able to communicate defined boundaries 18-1, 18-2 or applied regions between the implements 1-1, 1-2, 1-3 such that each is able to plot paths between fields F₁-F₃ such that adjacent rows (represented variously at guidance paths 8-1, 8-2, 8-3) are aligned between those fields F₁-F₃. It is appreciated that in various implementations, the implements 1-1, 1-2, 1-3 can also be the same implement on successive runs, as would be appreciated.

Certain implementations of the system 10 comprising the management system 30 use collected or stored data—such as previous year's data and field boundary data—that is collected and then displayed via the display 14 or stored in the cloud and accessed via communications systems 6 to guide the operator or steering system 2 along their field edge so as to not have overlap or large skips in the areas where multiple fields meet each other or are otherwise adjacent.

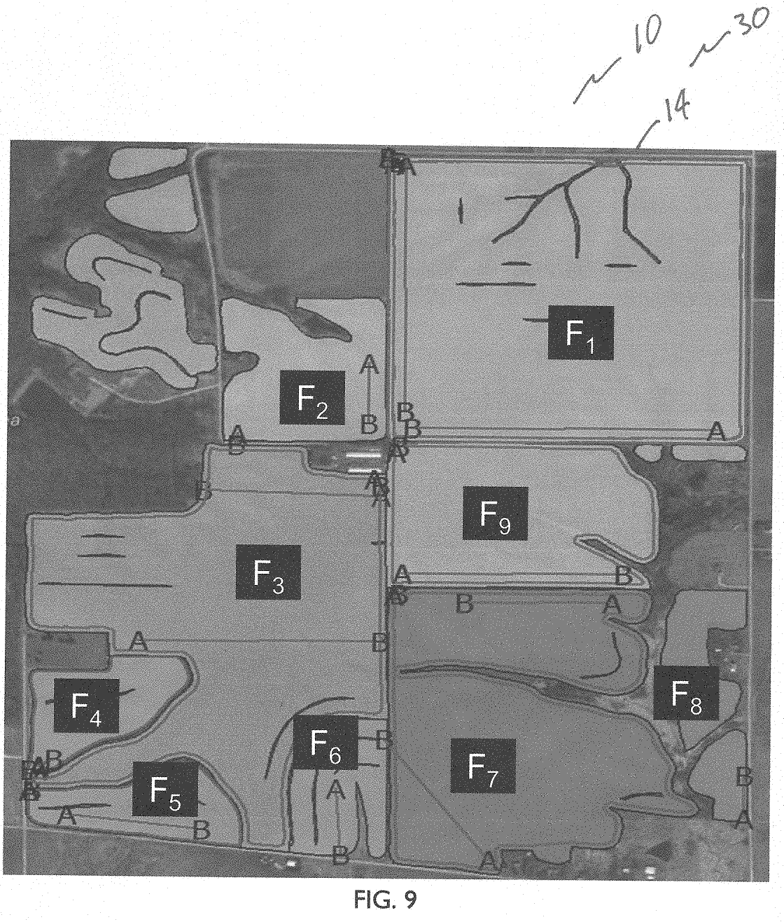

For example, and as shown in FIG. 9, the system 10 according to certain of these implementations utilizes data from prior years and known boundaries to create A-B guidance paths in such a way that rows in different but adjacent fields F1-F9 are aligned as shown in FIG. 9. That is, to have the proper and most efficiently drawn guidance paths at the boundaries of the various fields F₁-F₉. It is understood that these implementations also provide the ability for the user to mark the locations of field fence posts as a way to indicate the field boundaries and improve overall operation of the guidance system 30, such as through machine learning.

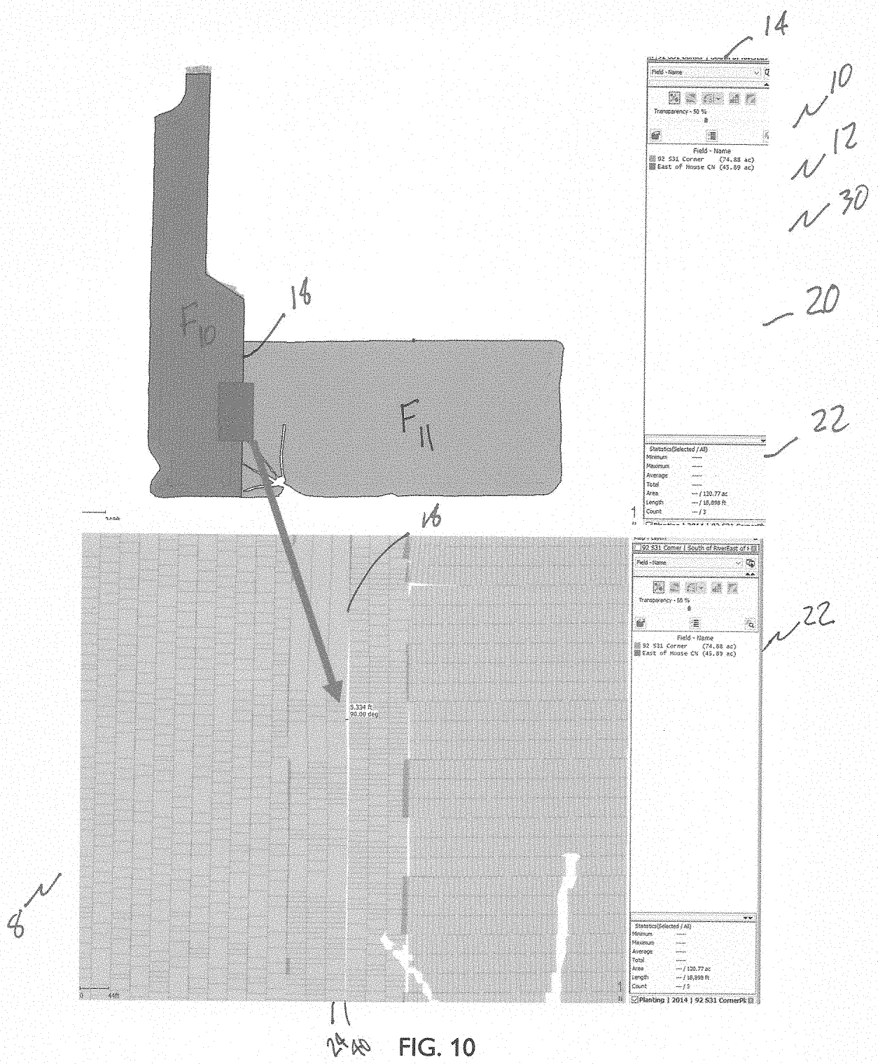

In certain implementations, the management system 30 is configured to allow the relevant implements 1-1, 1-2, 1-3 to interact with one another, such that via electronic communications via communications components 6 shown, for example, in FIGS. 1A-1B. As such, the plotted guidance paths 8-1, 8-2 can be shared between users on several implements at the enterprise level, such as via cellular, LTE, internet, VPN or other communications systems 6. These implementations are thus designed such that the paths 8-1, 8-2 are drawn together in adjacent fields A, B by adjacent users, as is shown in FIGS. 8-10, so as to be viewable to multiple implements/users, as shown in FIG. 10 via the communications component 6 and/or cloud 110 system discussed above in relation to FIG. 1B, which is optionally encrypted for data privacy. It is further appreciated that such adjacent field A, B mapping can also be used by a single operator for successive planting of the fields A, B.

Various implementations of the system 10 and path system also feature an optional corner squaring adjustment system 50, as shown in FIG. 11. It is understood that the various implementations of the corner squaring adjustment system 50 are able to be integrated with the other steering and guidance functions described herein, as discussed in relation to FIG. 2. It is further understood that the corner squaring adjustment system 50 can be presented to the operator prior to beginning the field or during the traversal of the field or both, as would be readily appreciated.

These implementations are a technical improvement over current systems that do not manage the guidance approach to corners in fields. That is, it is understood that the radius of turns tightens through concentric paths 8-1, 8-2 as the paths move inward, such that in inner paths it may not be possible to “make” the turn that was made on an outer path. The corner squaring adjustment system 50 addresses this issue by recognizing the turning capacity of the implement and then either suggesting an outer path 8-1 with sufficient radius to accommodate turns on the inner paths 8-2 and/or by suggesting square paths 8-2A, 8-2B where appropriate, as would be appreciated by the skilled artisan.

It is understood that autosteering headlands when planting is beneficial. However, the operator typically has to manually operate the steering when squaring off sharp corners. To do this, the operator has to manually drive straight into the prior path, which can be difficult. The corner squaring system 50 according to certain implementations addresses these challenges by automatically querying the operator when a path corner radius falls below a defined threshold and plotting squared off headland pass paths. These implementations represent a technical improvement because today a farmer has to manually drive in these situation, while the cornering system allows for automated steering to be used.

As shown in FIG. 11, paths 8-1 and 8-2 are generated from the boundary 18. It is understood that the first path 8-1 can make a round corner, but the second path 8-2 makes a round corner (shown at Z) but it is too sharp for the planter to plant around. Therefore, the squared off paths 8-2A, 82-B are plotted by corner squaring adjustment system 50 so that the tractor can stay engaged on the path and plant straight into path 8-1 to square off the corner. The operator reverses the implement perpendicular to the previous path and engages on the second path, that is proceeding out of path 8-1 and into path 8-2 after the corner, thus creating a square corner as would be readily appreciated.

It is understood that a decision point is thus presented that is queried on the display by the corner squaring adjustment system 50: while steering on path 8-2, the system 10 needs to anticipate and account for the approaching corner and determine if the corner squaring system 50 should steer around that corner, or if it should be squared off. Certain implementations of the system 50 utilize a user defined minimum radius to establish which approach is preferable, such as by evaluating the approaching corner, the system 10 is able to see if the turn meets or exceeds an established threshold relating to the minimum radius of a turn they find acceptable on the headlands, or with their planter in general.

If the approaching curve would require a turn radius less than the minimum, then it would switch to a square corner and generate the paths 8-2A and 8-2B. Alternatively, the user is able to define which corners they want rounded and which corners they want squared off.

In use, the system 10 also comprises an optional corner squaring system 50 can be used to square off outside corners as well as inside corners. It is understood that in certain circumstances, the ability to square off a corner is helpful on the first (8-1) and second (8-2) paths as well as the third (8-3) and/or fourth (8-4) paths if the operator requires more than two.

For illustration, the planting operation was used in the example of FIG. 11, but it is appreciated that in alternate implementations such corner squaring adjustment system 50 guidance is useful for other operations like tilling, spraying, fertilizing, and harvesting. Additional implementations would be readily apparent to those of skill in the art.

In certain implementations, the system evaluates the radius of an individual guidance path 8 turn and if the radius falls below a specified or defined threshold, the display 14 and/or GUI 22 presents the operator with the option to square off the turn as described above. Various implementations initiate an algorithm to generate a straight path within the square off area, as shown in the squared off paths 8-2A, 8-2B of FIG. 11. Further implementations are possible.

Although the disclosure has been described with reference to preferred embodiments, persons skilled in the art will recognize that changes may be made in form and detail without departing from the spirit and scope of the disclosed apparatus, systems and methods.

What is claimed is:

1. An agricultural vehicle guidance visualization system for use with an automatic steering unit, comprising:
a) an operations unit;
b) a display running a graphical user interface; and
c) a path system in operational communication with the operations unit and display, the path system configured to:
i) input one or more field boundaries for a polygonal field map;
ii) plot a plurality of guidance paths;
iii) display heading, position, and offset for the plurality of plotted guidance paths; and
iv) adjust the heading, position, and/or offset of the plurality of plotted guidance paths.

2. The system of claim 1, wherein the path system is configured to command the automatic steering unit with the plurality of plotted guidance paths.

3. The system of claim 2, wherein the path system is configured to display and adjust the plurality of plotted guidance paths with at least one of an enterprise data adjustment, a squaring adjustment, or an offset adjustment.

4. The system of claim 3, wherein the squaring adjustment is configured to:
a) determine a guidance path corner radius; and
b) display a user prompt querying a square off option.

5. The system of claim 1, wherein the path system is configured to display field obstacles.

6. The system of claim 1, wherein the one or more field map boundaries are drawn from stored boundary map data.

7. The system of claim 6, wherein the path system is configured to populate the stored boundary map data with one or more additional boundary points.

8. A visualization and guidance method for use with an agricultural vehicle automatic steering unit comprising executing a path system configured to:
a) plot a plurality of guidance paths in a field map via one or more field map boundaries;
b) display the plurality of plotted guidance paths and any skips and overlaps for adjustment of plotted guidance path heading, position, and offset.

9. The method of claim 8, wherein the path system is configured to command the automatic steering unit.

10. The method of claim 8, wherein the path system is configured to display field map overlaps and skips.

11. The method of claim 1, wherein the path system is configured to utilize user defined offsets.

12. A visualization and guidance system for use with automatic steering of an agricultural vehicle, comprising a path system configured to run on an operations unit and in-cab display, wherein the path system is configured to:
a) input one or more field boundaries in a polygonal field map on the display;
b) plot a plurality of guidance paths in the polygonal field map for display;
c) display path heading position and offset for the plurality of guidance paths throughout the plotted field map; and
d) adjust the heading, position and offset of the plurality of guidance paths.

13. The visualization and guidance system of claim 12, wherein the path system is configured to command the automatic steering unit.

14. The visualization and guidance system of claim 13, wherein the operations unit is in operational communication with a cloud server.

15. The visualization and guidance system of claim 12, further comprising a squaring adjustment system.

16. The system of claim 12, configured to command a steering unit.

17. The system of claim 12, wherein the system is configured to plot guidance paths through the field region on the basis of a user-defined A-B path.

18. The system of claim 12, wherein the path system is configured to display guidance path headings, positions, skips, and overlaps.

19. The system of claim 12, wherein the path system is configured to apply user defined offsets.

20. The system of claim 12, further comprising an enterprise management system.
